(19) United States
(12) Patent Application Publication
(10) Pub. No.: US 2026/0297924 A1
(43) Pub. Date: Oct. 1, 2026

(54) ADDITIVELY MANUFACTURED FORMWORK ASSEMBLIES AND SEQUENTIAL CAST-IN-PLACE METHODS TO CREATE COMPRESSION-BASED STRUCTURES

(71) Applicant: The Regents of the University of Michigan, Ann Arbor, MI (US)

(72) Inventors: Mania AGHAEI MEIBODI, Ann Arbor, MI (US); Zaid MARJI, Ann Arbor, MI (US); Stuti BINDLISH, Ann Arbor, MI (US)

(73) Assignee: The Regents of the University of Michigan, Ann Arbor, MI (US)

(21) Appl. No.: 19/476,953

(22) PCT Filed: Apr. 22, 2024
(86) PCT No.: PCT/US2024/025669

§ 371 Date: Oct. 20, 2025

Related U.S. Application Data
(60) Provisional application No. 63/461,159, filed on Apr. 21, 2023.
(60) Provisional application No. 63/538,321, filed on Sep. 14, 2023.

(51) Int. Cl. E04B 1/16; B28B 23/22; B33Y 80/00; E01D 19/00; E01D 101/24

(52) U.S. Cl. CPC E04B 1/167; B28B 23/22; E01D 19/00; B33Y 80/00; E01D 2101/24

(57) ABSTRACT

A method of making a compression-based structure includes introducing a first amount of a slurry material into at least one first opening of a first casting channel in fluid communication with an open volume of an additively manufactured formwork. One or more temporary scaffold supports support the formwork. The open volume defines the compression-based structure and one or more hydrostatic membranes may be disposed therein. The introducing the first amount of slurry fills the open volume to a first level. An additional amount of slurry is introduced into at least one additional opening of an additional casting channel of the formwork in fluid communication with the open volume so that the additional amount of slurry fills the open volume to a second level above the first level. The slurry solidifies to form the compression-based structure within the formwork on the surface. Additively manufactured/3D printed formwork assemblies are also provided.

### CROSS-REFERENCE TO RELATED APPLICATIONS

This application claims the benefit of U.S. Provisional Application No. 63/461,159, filed on Apr. 21, 2023 and U.S. Provisional Application No. 63/538,321, filed on Sep. 14, 2023. The entire disclosures of each of the above applications are incorporated herein by reference.

### FIELD

The present disclosure relates to methods of making a compression-based structure by sequential casting-in-place of an open volume of an additively manufactured/3D printed formwork, which may be additively manufactured/3D printed in advance, delivered to the location of casting and assembled.

### BACKGROUND

This section provides background information related to the present disclosure which is not necessarily prior art.

Compression-based or compression-only structures, also referred to as pure compression structures, are engineering structures that rely predominantly or solely on the compressive forces acting on their components for stability. In other words, these structures are typically designed to resist external loads through compression without any tensile or bending forces. Compression-based structures, including arches, domes, vaults, and shells, can take various forms, including that of slabs, bridges, beams, ribbed structures, such as gothic vault systems and buttresses, and other large scale infrastructure. Typically, such compression-based structures are constructed using stone and brick masonry, which possess high compressive strength but lack significant bending properties.

One of the most notable advantages of compression-based structures is their improved strength-to-weight ratio. The strength achieved through geometry in compression-only structures has been demonstrated in works of Phillippe Block using materials like prefabricated stone (e.g., Armadillo Vault stone structure), bricks (e.g., sustainable, affordable housing for South Africa), tiles (e.g., Free-form Tile Vault), recently 3D printing concrete components without reinforcement considered as an artificial stone (e.g., striatus-3D concrete printed masonry bridge), and Mycelium (MycoTree). In all these structures, components are prefabricated (mostly pre-cut in case of stone or 3D printed in advance), then placed in the compression-only form to ensure forces travel to supports in pure compression. This reduces the need for excessive material accumulation as in conventional concrete beams and flat floor slabs. Due to their unique design, the compression-based structures require less material to span space, resulting in decreased material consumption and enhanced design flexibility.

This presents opportunities to reduce material usage significantly. Despite the benefits of these materials, transporting these units to the construction site poses risks of damage. Constructing compression-only structures using components such as brick, pre-cut stones, or 3D-printed concrete blocks requires heavy scaffolding structures to support the weight of many building parts during construction which results in higher cost of construction and limited accessibility, as well as involving subtractive manufacturing, leading to material wastage. While weight of individual components is an important consideration in scaffolding requirements during construction, additional factors, such as the size and handling of various materials, contribute to the need for excessive scaffolding. For instance, smaller stones and tiles might require excessive scaffolding due to their dimensions. Similarly, even in the case of 3D-printed concrete, the weight of the components necessitates careful handling during assembly, which can impose limitations on the maximum size that can be practically managed. The depreciation of scaffolding involves a comprehensive consideration of the weight of components and the sizes of materials being used and their ease of handling during construction. Materials are also limited to what can be prefabricated and then transported safely to the construction site for assembly. It would be desirable to have the ability to form compression-based structures with alternative methods using fewer materials or materials having a reduced-impact on pollution with a diminished need for scaffolding for cast-in-place construction.

### SUMMARY

This section provides a general summary of the disclosure, and is not a comprehensive disclosure of its full scope or all of its features.

In certain aspects, the present disclosure relates to a method of making a compression-based structure. The method may comprise introducing a first amount of a slurry material into at least one first opening of a first casting channel in fluid communication with an open volume of an additively manufactured formwork. The open volume of the formwork defines the compression-based structure and the introducing the first amount of slurry fills the open volume to a first level. The additively manufactured formwork is supported by one or more scaffold supports. The one of more scaffold supports may extend from a surface. The method also comprises further introducing an additional amount of slurry into at least one additional opening of an additional casting channel of the formwork that is in fluid communication with the open volume so that the additional amount of slurry fills the open volume to a second level above the first level. In this manner, the slurry solidifies to form the compression-based structure within the formwork.

In one aspect, the formwork further comprises at least one hydrostatic membrane disposed in the open volume of the formwork lower than a height of the at least one first opening of the first casting channel.

In one further aspect, the open volume defines a longitudinal axis and the at least one hydrostatic membrane is disposed in the open volume in an orientation substantially orthogonal to the longitudinal axis.

In one further aspect, the at least one hydrostatic membrane defines an interface between the first level and the second level.

In one further aspect, the at least one hydrostatic membrane comprises at least one vent.

In one aspect, the at least one additional opening comprises a second opening in a second casting channel of the formwork that is in fluid communication with and connects to the open volume and a third opening in a third casting channel of the formwork that is in fluid communication with and connects to the open volume. The additional introducing may thus further comprise introducing at least a second amount of the slurry material into the second opening of the second casting channel of the formwork. The second amount of the slurry material fills the open volume to a second level above the first level. The method may include further introducing at least a third amount of the slurry material into the third opening of the third casting channel of the formwork, so that the third amount of the slurry material fills the open volume to a third level above the second level.

In one further aspect, the formwork further comprises at least one first hydrostatic membrane disposed in the open volume of the formwork lower than a first height of the at least one first opening of the first casting channel and at least one second hydrostatic membrane disposed in the open volume of the formwork lower than a second height of the at least one second opening of the second casting channel.

In one further aspect, the open volume defines a longitudinal axis and each of the at least one first hydrostatic membrane and the at least one second hydrostatic membrane is disposed in the open volume in an orientation substantially orthogonal to the longitudinal axis.

In one further aspect, the at least one first hydrostatic membrane defines an interface between the first level and the second level and the at least one second hydrostatic membrane defines an interface between the second level and the third level.

In one further aspect, the at least one first hydrostatic membrane and the at least one second hydrostatic membrane each comprise at least one vent.

In one aspect, the compression-based structure is a monolithic solid having layers corresponding to the first level, the second level, and the third level.

In one aspect, the introducing the first amount of the slurry material comprises introducing the first amount of slurry material into at least two distinct first openings of two distinct first casting channels in fluid communication with the open volume so the first amount of slurry material fills the open volume to a first level and the further introducing the additional amount of slurry material comprises introducing the additional amount of slurry material into at least two additional openings of two additional casting channels in fluid communication with the open volume so that the additional amount of slurry material fills the open volume to the second level above the first level.

In one further aspect, the formwork further comprises at least two first hydrostatic membranes disposed in the open volume of the formwork lower than a first height of the at least two distinct first openings of the two distinct first casting channels and at least two second hydrostatic membranes disposed in the open volume of the formwork lower than a second height of the at least two distinct second openings of the two distinct second casting channels.

In one aspect, the compression-based structure defines at least one arch, dome, vault, shell, slab, bridge, ceiling, beam, or ribbed structure.

In one aspect, the additively manufactured formwork comprises a polymeric material.

In one aspect, the further introducing the additional amount of slurry occurs greater than or equal to about 5 minutes to less than or equal to about 24 hours after the introducing of the first amount of slurry.

In one aspect, the slurry material comprises a material selected from the group consisting of: cementitious materials, clay, earth-based materials, masonry, starch, dirt, bio-material, and combinations thereof.

In one aspect, the slurry material comprises an accelerator.

In one aspect, the additively manufactured formwork comprises multiple segments connected to one another.

In one aspect, the compression-based structure is formed on a surface and the compression-based structure includes at least two supporting portions that each contact the surface on one end.

In one further aspect, the method further comprises assembling the additively manufactured formwork. The at least two supporting portions of the formwork respectively define a first member having a first end and a second member having a second end. The assembling comprises anchoring the first end to the surface and the second end to the surface, followed by disposing the one or more scaffold supports between the surface and one or more intermediate points along the first member and the second member.

In one aspect, the method further comprises adding one or more upper segments of the additively manufactured formwork to connect at least the first member and the second member.

In one aspect, the compression-based structure is formed on a surface and the compression-based structure includes at least three supporting portions that each contact the surface on one end.

In one further aspect, the method further comprises assembling the additively manufactured formwork. The at least three supporting portions each respectively defining a first member having a first end, a second member having a second end, and a third member having a third end, wherein the assembling comprises anchoring the first end to a surface, the second end to the surface, and the third end to the surface, followed by placing the one or more scaffold supports between the surface and one or more intermediate points along the first member, the second member, and the third member.

In one aspect, the method further comprises removing the one or more scaffold supports after the slurry material has solidified and formed the compression-based structure.

In one aspect, the method further comprises removing the additively manufactured formwork after the slurry material has solidified and formed the compression-based structure.

In one aspect, the compression-based structure is free of any metal reinforcements.

In one aspect, the open volume of the additively manufactured formwork further comprises at least one metal reinforcement and after the slurry material solidifies, the compression-based structure comprises the at least one metal reinforcement.

In certain other aspects, the present disclosure further relates to an additively manufactured formwork for making a compression-based structure. The additively manufactured formwork comprises an additively manufactured polymeric structure defining an open volume. The open volume is configured to receive a slurry material and corresponding to the compression-based structure including at least one supporting portion having at least two openings. The formwork thus includes a first opening of a first casting channel at a first elevation in fluid communication with the open volume. The formwork further includes a second opening of a second casting channel at a second elevation above the first elevation in fluid communication with the open volume. The at least one supporting portion defines one or more first regions configured to have a support scaffold structure disposed thereunder.

In one aspect, the formwork further comprises a first hydrostatic membrane disposed in the open volume of the formwork at the first elevation that is lower than the first height of the first opening of the first casting channel.

In one further aspect, the first hydrostatic membrane comprises at least one vent.

In one aspect, the at least one supporting portion comprises at least two supporting portions. The additively manufactured structure comprises a first member defining a first supporting portion of the compression-based structure and having the first opening of the first casting channel at the first elevation in fluid communication with the open volume. The first supporting portion also comprises the second opening of the second casting channel at the second elevation above the first elevation in fluid communication with the open volume. The first member defines the one or more first regions configured to have the support scaffold structure disposed thereunder. The at least two supporting regions further comprise a second member defining a second supporting portion of the compression-based structure and having at least two openings. The at least two openings include a third opening of a third casting channel at the first elevation in fluid communication with the open volume and a fourth opening of a fourth casting channel at the second elevation above the first elevation in fluid communication with the open volume. The second member defines one or more second regions configured to have the support scaffold structure disposed thereunder.

In one further aspect, the formwork further comprises a first hydrostatic membrane disposed in the open volume of the formwork at the first elevation that is lower than a first height of the first opening of the first casting channel. The formwork further comprises a second hydrostatic membrane disposed in the open volume of the formwork at the second elevation that is lower than a second height of the second opening of the second casting channel. The formwork further comprises a third hydrostatic membrane disposed in the open volume of the formwork at the first elevation that is lower than a third height of the third opening of the third casting channel. The formwork also comprises a fourth hydrostatic membrane disposed in the open volume of the formwork at the second elevation that is lower than a fourth height of the fourth opening of the fourth casting channel.

In one further aspect, the first hydrostatic membrane, the second hydrostatic membrane, the third hydrostatic membrane, and the fourth hydrostatic membrane each comprises at least one vent.

In one further aspect, the open volume in the first member defines a first longitudinal axis and the open volume in the second member defines a second longitudinal axis wherein each of the first hydrostatic membrane and the second hydrostatic membrane are disposed in the open volume of the first member in an orientation substantially orthogonal to the first longitudinal axis and the third hydrostatic membrane and the fourth hydrostatic membrane are disposed in the open volume of the second member in an orientation substantially orthogonal to the second longitudinal axis.

In one further aspect, the additively manufactured polymeric structure further comprises at least a third member defining a third supporting portion of the compression-based structure and having at least two openings. The at least two openings include a fifth opening of a fifth casting channel at the first elevation in fluid communication with the open volume. The at least two openings also comprise a sixth opening of a sixth casting channel at the second elevation above the first elevation in fluid communication with the open volume. The third member defines one or more first regions configured to have a support scaffold structure disposed thereunder.

In one further aspect the formwork further comprises a fifth hydrostatic membrane disposed in the open volume of the formwork at the first elevation that is lower than a fifth height of the fifth opening of the fifth casting channel. The formwork also comprises a sixth hydrostatic membrane disposed in the open volume of the formwork at the second elevation that is lower than a sixth height of the sixth opening of the sixth casting channel.

In one further aspect, the open volume in the third member defines a third longitudinal axis, wherein each of the fifth hydrostatic membrane and the sixth hydrostatic membrane are disposed in the open volume of the third member in an orientation substantially orthogonal to the third longitudinal axis.

In one further aspect, the fifth hydrostatic membrane and the sixth hydrostatic membrane each comprises at least one vent.

In one further aspect, the formwork further comprises a first holding component disposed between the one or more first regions of the first member and the support scaffold structure and a second holding component disposed between the one or more second regions of the second member and the support scaffold structure.

In one further aspect, the additively manufactured polymeric structure further comprises one or more upper segments connecting at least the first member and the second member, wherein the one or more upper segments each comprises an additional opening and an additional casting channel connected to the open volume of the additively manufactured formwork.

In one aspect, the additively manufactured formwork comprises multiple segments connected to one another.

In one aspect, the open volume of the additively manufactured polymeric structure is free of any metal reinforcements.

In one aspect, the open volume of the additively manufactured formwork further comprises at least one metal reinforcement and after the slurry material solidifies, the compression-based structure comprises the at least one metal reinforcement.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1A-1I show a method of making a compression-based structure with a multi-segment additively manufactured lightweight formwork. FIGS. 1A-1D generally show the steps of assembling the multi-part lightweight additively manufactured formwork on the site where the compression-based solid structure is to be formed. In the example (prototype) shown, each member (e.g., a wing or arm) is made of three large-scale 3D printed formwork segments. In total, this exemplified structure has a plurality of 3D-printed formwork segments (here 54 segments, but the number can vary depending on how large the formwork is to be printed, etc.) that are assembled. In certain variations, assembly of the segments may be sequential or in other variations, might happen non-sequentially based on how the segments interlock with one other. After assembling all the formwork components in compression-only form, slurry material (e.g., concrete) may be introduced and cast in formwork in sequence. FIGS. 1E-1G generally show the cast-in-place method that includes steps of sequentially adding slurry material to the assembled multi-part lightweight additively manufactured formwork to form a solid compression-based structure. The right wing of the model is 3D-printed polymeric formwork assembled into a compression-based form that includes multiple openings to casting channels (spurs or sprues). The left wing of the model has been cast with concrete in three sections, labeled sequentially as sections A, B, and C from left to right, each respectively having a first elevation or level, a second elevation or level, and a third elevation or level. In FIG. 1H, the slurry material solidifies by hardening and/or setting while one or more temporary scaffold supports remain in place supporting the lightweight additively manufactured formwork. In FIG. 1I, the slurry material has solidified into the solid compression-based structure.

FIG. 2 shows a depiction of cast solid compression-based structure formed via sequential casting in a multi-segment additively manufactured lightweight formwork assembly prepared in accordance with certain aspects of the present disclosure.

FIGS. 3A-3F show a plurality of hydrostatic membranes incorporated into a multi-segment additively manufactured lightweight formwork according to certain variations of the present disclosure. FIG. 3A shows dominant flow of compressive forces within an internal open volume of a representative segment of the formwork, while FIG. 3B shows an orientation or alignment of a hydrostatic membrane perpendicular to a direction of the dominant compressive forces. FIGS. 3C and 3D show the segment of formwork with hydrostatic membranes before adding a first amount of slurry (FIG. 3C) and after adding the first amount of slurry (FIG. 3D). FIG. 3E is a magnified view of a region of the segment showing a casting channel with an inlet and a hydrostatic membrane disposed in the open volume where the slurry initially fills the open volume at a level parallel to ground, whereas FIG. 3F shows the same region after the slurry has been filled to a first level showing that the hydrostatic membrane ensures that cold joints between sequentially cast sections are perpendicular to the dominant flow of compressive forces while casting.

FIGS. 4A-4C generally show the cast-in-place method that includes steps of sequentially adding slurry material to the assembled multi-part lightweight additively manufactured formwork having a plurality of hydrostatic membranes disposed therein to form a solid compression-based structure. FIG. 4A shows the slurry material added to the assembled multi-part lightweight additively manufactured formwork after a first casting cycle filled to a first level, where the slurry material fills the open volume up to the first level corresponding to hydrostatic membranes. FIG. 4B shows the slurry material added to the formwork after a second casting cycle where slurry material is filled to a second level above the first level, where the slurry material fills the open volume up to the second level corresponding to hydrostatic membranes. FIG. 4C shows a final, third casting cycle where slurry material fills all remaining open volume of the formwork to a third and final level disposed over the second level, where after the slurry material has solidified, a solid compression-based structure is formed.

FIG. 5 shows a plurality of metal reinforcement components incorporated into a multi-segment additively manufactured lightweight formwork according to certain variations of the present disclosure.

FIGS. 6A-6E. FIG. 6A shows a discretized assembled multi-part lightweight additively manufactured formwork having a plurality of segments formed via additive manufacturing, where the formwork is supported by a scaffolding system at least partially formed by additive manufacturing according to certain aspects of the present disclosure. FIGS. 6B-6C show three discrete segments of the formwork. FIG. 6B shows a first segment and a second segment prior to being joined and assembled, while FIG. 6C shows the first segment and second segment coupled and assembled together. FIG. 6D shows the first segment further attached to a third segment or anchor. FIG. 6E shows a magnified view of a representative male-female connector joint between two segments that helps to ensure a fluid-tight seal between respective segments of the assembled formwork according to certain embodiments of the present disclosure.

FIG. 7 shows a solid compression-based structure bearing load (of a human) without any metal reinforcements formed via a cast-in-place method of sequential addition of slurry into a multi-part lightweight additively manufactured formwork according to certain variations of the present disclosure.

FIG. 8 shows a plurality of fifty-four (54) discretized segments formed via additive manufacturing that can be used to form one example embodiment of a multi-part lightweight additively manufactured formwork according to certain variations of the present disclosure.

FIG. 9 shows an alternative view of a solid compression-based structure bearing load (supporting a substrate/platform and two humans) without any metal reinforcements formed via a cast-in-place method of sequential addition of slurry into a multi-part lightweight additively manufactured formwork according to certain variations of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

In various aspects, the present disclosure provides methods of forming compression-based structures by using additively manufactured or three dimensionally printed (3D) printed lightweight formwork. The methods provided by certain aspects of the present disclosure thus can be used to construct compression-based structures (made by casting a slurry material, which may comprise a cementitious material that forms concrete, masonry, earth, and the like) based on prefabrication of a large-scale additively manufactured/3D-printed lightweight formwork. In certain aspects, the methods may further involve additively manufacturing or 3D printing a lightweight formwork with designated inlets to open volume (which is continuous and enables fluid communication) inside of the formwork, which defines the compression-based structure that includes at least one or optionally two or more supporting portions (e.g., load-bearing portions) in contact with an underlying surface (e.g., substrate or ground), and is designed for the on-site casting of a slurry based material (e.g., cementitious-based material like concrete, clay, earth-based, dirt, bio-material, or any castable material). Such a lightweight formwork, being much lighter than traditional materials, allows for the handling of relatively larger sized components during assembly. As a result, the need for extensive scaffolding of the formwork is reduced.

Additive manufacturing (AM) also commonly referred to as three-dimensional (3D) printing, is a process by which material is applied in an additive, layer-by-layer formation technique. In certain aspects, an additive manufacturing process may include any of the following processes, robotic extrusion based 3D printing, resin printing, fused filament fabrication (FFF) printing, fused deposition modeling (FDM), stereolithography (SLA), selective laser sintering (SLS), binder jetting (BJ), and the like. In these processes, a polymer or polymeric precursor may be treated, for example, heated to flow and melt. Any thermoplastic or thermoset polymer may be used or any material that is printable via the processes described above. By way of non-limiting example, laser sintering is a process involving the construction of a three-dimensional article by selectively projecting a laser beam having the desired energy onto a layer of particles of the polymer material to be sintered. The 3D printing process can be paired with modeling or image data and/or parameters received from a customized model of the compression-based structure to be formed via the present technology. Various known polymer materials that can be 3D printed on a scale of 1 cm or greater can be used to form the additively manufactured formwork. The polymer may be a thermoplastic in certain variations. By way of non-limiting example, suitable polymers for 3D printing include acrylonitrile butadiene styrene (ABS), ABS resin, polyethylene terephthalate glycol (PETG), polyesters like, polylactic acid (PLA), and the like. In one variation, the formwork may be SLA 3D printed with an ABS-like resin or standard resin. In another variation, the formwork may be printed by robotic pellet extrusion with polymers such as PLA, PETG, and ABS pellets. In certain other variations, the formwork may comprise a composite with a polymer, which may include a polymeric matrix having a reinforcement phase or material distributed therein. By way of non-limiting example, the reinforcement phase may be carbon fiber or wood-based materials, such as wood filaments. Thus, the material may comprise a carbon fiber composite or a wood-plastic composite that includes wood filament (in a thermoplastic and/or thermoset matrix).

Polymers can be manufactured into a formwork using an additive manufacturing process, like those described above. In certain variations, the formwork can remain in place over the cast solid structure, while in other variations, the formwork can be removed after casting. In certain variations, the polymer/plastic may be biodegradable such that it will degrade over time, for example when exposed to elements in the environment, such as moisture in the air or precipitation or the formwork may be removed by dissolving it by immersion in a solvent or by other removal techniques. In certain aspects, the formwork may be reused. The formwork may be lightweight and integrative and formed with polymeric materials (e.g., plastic) described above, materials containing carbon fibers, or biopolymer materials, by way of example.

In certain variations, the additively manufactured formwork may be an assembly of multiple distinct segments, such that the methods may involve assembling the segments of the formwork into a compression-based shape or form using a minimal scaffolding system. In certain aspects, the method involves casting the liquid slurry material (e.g., a cementitious slurry material that is a precursor for concrete) into one or more inlets of the formwork. The casting or introducing the liquid slurry may be done in sequences. In certain variations, the liquid slurry may be pressurized as it is introduced into inlets of the formwork. The method may involve sequentially pouring batches or amounts of the slurry material at staggered times, offset from one another, to permit the setting and at least partial solidification of cast material. In a structure made from a typical concrete mix (without an accelerator), the method involves pouring the slurry material that will form concrete into the open volume of the formwork to a first level or elevation, allowing it to set, and then pouring the next section to a second level or elevation above the first level. In other variations, the method involves pouring a set-on-demand cementitious material comprising an accelerator as the slurry material that will rapidly set and form concrete into the open volume of the formwork to a first level or elevation, allowing it to set with minimal or no waiting time, and then pouring the next section to a second level or elevation above the first level.

In certain aspects, the present disclosure contemplates a method of making a compression-based structure. The method may comprise introducing a first amount of a slurry material into at least one first opening of a first casting channel in fluid communication with an open volume inside of an additively manufactured (e.g., 3D printed) formwork. The open volume of the formwork defines the compression-based structure to be formed by casting, which may include one or more supporting portions or members/arms. The formwork thus defines a shell structure around the open volume having the shape of the solid structure to be formed after it is filled. The additively manufactured formwork is supported by one or more temporary scaffold supports. The temporary scaffold supports may extend from a surface, such as the ground or the floor. The positioning of these scaffolds can be determined by minimizing formwork deformation during casting and curing (or considering any live load, as well as dead load). As discussed above, the present disclosure only requires minimal scaffolding as compared to other traditional methods of constructing compression-only structures, such as the work of Philipe Block or Felix Candalas.

The first amount of slurry material introduced into the formwork fills the open volume to a first level. The first amount of slurry material may set or at least partially solidify, such that it can support the weight of additional material being added into the formwork. Further, another consideration is that the formwork can withstand the hydrostatic pressure generated from concrete casting. The height of the hydrostatic pressure is important for every new sequence and is the indicator of helping to determine the number of casting cycles to be conducted. The height of the hydrostatic pressure is determined by the thickness of the formwork. As will be appreciated by those of skill in the art, full solidification of the structure may not occur (e.g., in cementitious materials) until well after 28 days after the casting process.

The method also includes further introducing an additional amount of slurry into at least one additional opening of an additional casting channel of the formwork that is in fluid communication with the open volume. In this manner, the additional amount of slurry fills the open volume to a second level above the first level. As will be described further herein, additional rounds of adding the slurry material may occur to sequentially build additional levels over the first and second levels to fill the open volume of the formwork and form the compression-based structure. The slurry material solidifies to form the compression-based structure within the formwork on the surface. The one or more scaffold supports (scaffolding) will remain in place during the solidification process. After the entire structure is cast, the scaffold support can be removed.

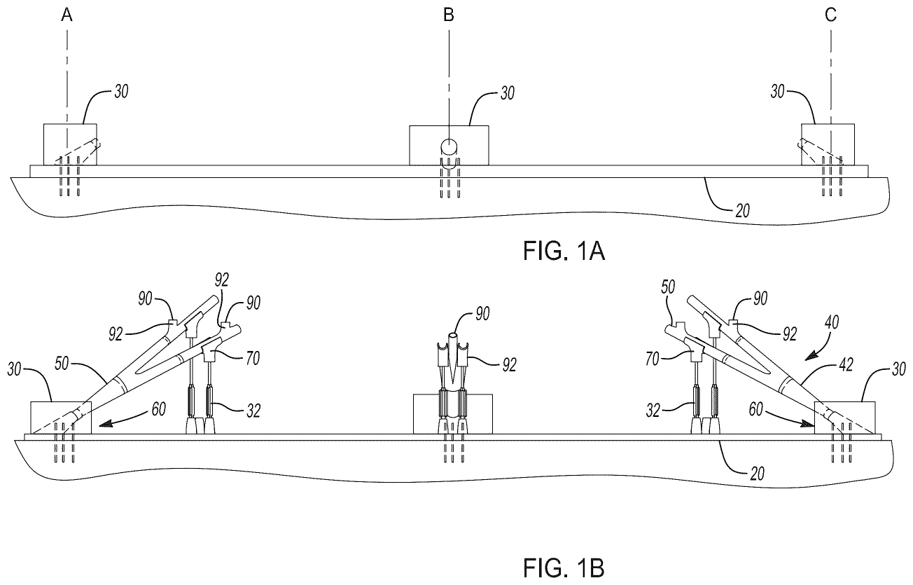

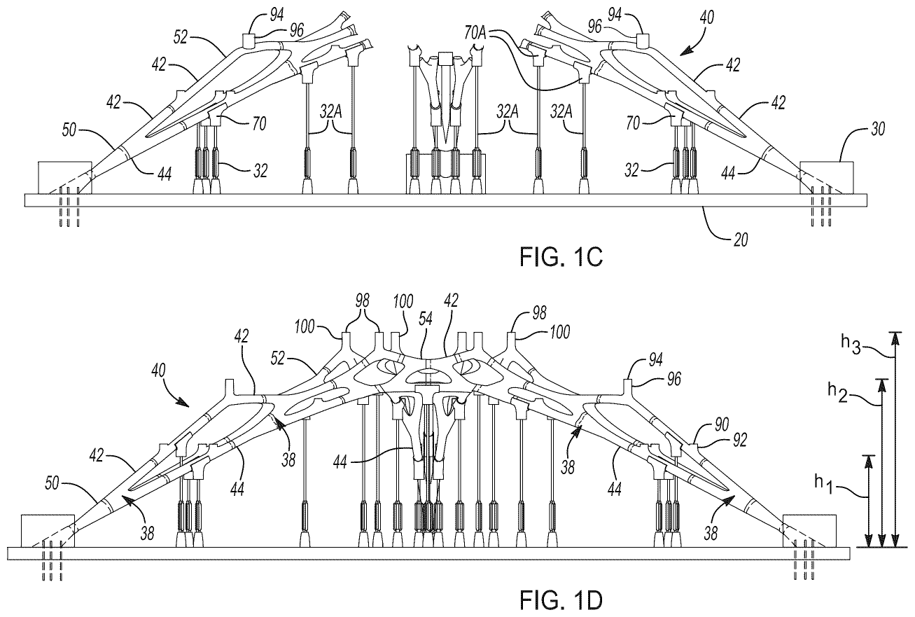

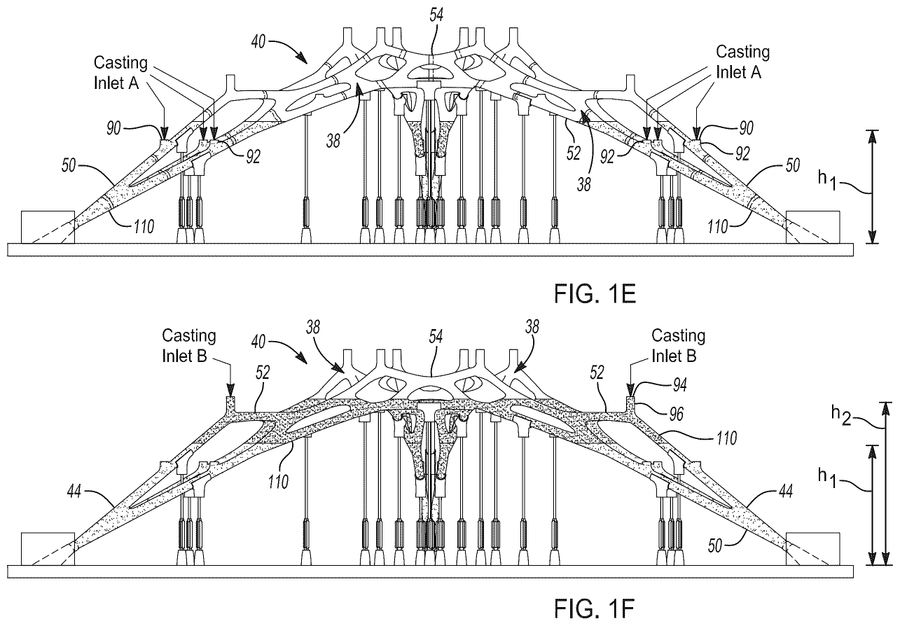

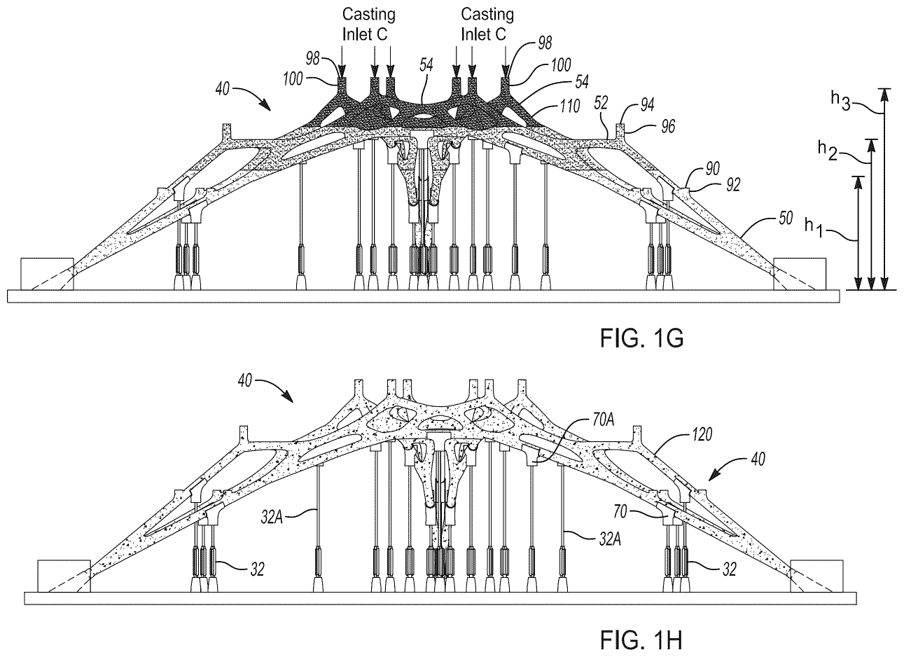

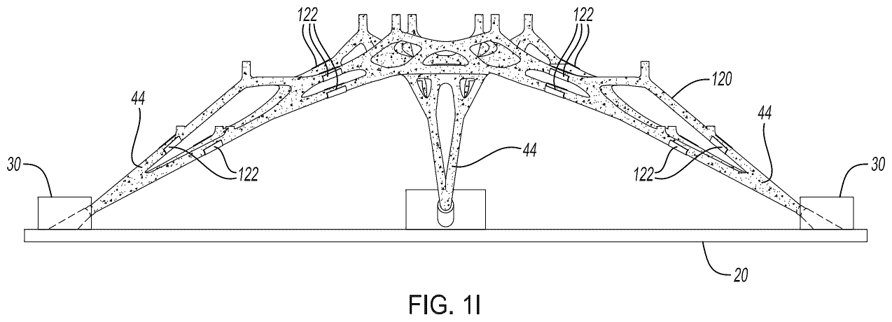

Such a method may be best understood in the context of FIGS. 1A-1I, by way of non-limiting example. FIGS. 1A-1D generally show the steps of assembling the multi-part lightweight additively manufactured formwork 40 on the site where the compression-based solid structure is to be formed. First, the process may include preparing a surface 20 (e.g., ground, floor, substrate) to receive the lightweight additively manufactured formwork. One or more anchors 30 (in FIG. 1A there are three anchors 30 being placed) may be fixed or coupled to the surface 20.

The additively manufactured formwork 40 may be divided into multiple smaller parts that are assembled either beforehand or during construction. In certain aspects, the additively manufactured formwork 40 comprises multiple segments 42 connected to one another. In certain aspects, these segments 42 are divided along planes perpendicular to the dominant direction of compressive forces to maintain the structural integrity of the formwork 40 when subjected to compression-only conditions. Each of the segments 42 of the formwork 40 may be configured to connect to one or more adjacent segments 42 of formwork 40, which may be sealed to eliminate leakage while casting. For example, formwork segment 42 connections/joint details may be mechanically coupled and/or structurally bonded together The representative example of the additively manufactured formwork 40 includes a plurality of distinct segments 42 (fifty-four (54) total) that will be assembled together, including segments 42 that define one or more supporting portions (e.g., three members or arms that each comprise a plurality of segments, for example, here 18 segments) of the compression-based structure that will be formed.

The supporting portion may be a structural element that contacts the ground and supports other regions of the compression-based structure. The supporting portions may be load-bearing regions, columns, or other structures that contact the surface 20 to support the compression-based structure. There may be a single supporting region, such as a column or multiple supporting regions or members (e.g., arms/legs), for example, two, three, four, five, six or more members (e.g., arms/legs) up to a hundred or more members (e.g., arms/legs). Instead of arms, the structure may feature column-like areas that meet the surface from the middle of the structure. Further, not all compression-based structures have arms. For instance, dome structures are examples of compression-only structures that do not feature arms. Thus, by way of example, in a design of a dome-shaped compression-based structure, there may be no arm or leg supporting structure, but rather the members are in the form of dome walls in contact with the underlying surface 20.

After assembly, the formwork 40 has an exterior shell and defines an open volume 38 (best seen in FIGS. 1D-1F) internally that will be filled with slurry material. When the respective segments 42 are assembled and connected to one another, for example in a sealed or fluid-tight manner, the internal open volume 38 in each respective segment 42 is in fluid communication with adjacent segments 42 as appropriate to permit the slurry material to flow internally and fill the open volume 38 having the shape and structure of the compression-based solid.

In the embodiment shown in FIGS. 1B-1I, the formwork 40 has three distinct supporting sections or members (e.g., arms 44) and includes a set of first casting segments 50 labeled as “A” that will define a first level of slurry filling, a set of second casting segments 52 labeled as “B” that will define a second level of slurry filling above the first level, and a set of third casting segments 54 that will define a third level of slurry filling above the first and second levels of slurry. Notably, each respective casting segment may in fact be formed of a plurality of smaller segments assembled together. As will be described further herein, the locations of the openings and casting channels are predetermined based on a casting height per fill cycle that is determined based on the formwork's 40 ability to resist hydrostatic pressure of the slurry material being cast. Further, where the formwork 40 includes multiple supporting sections or members (e.g., arms 44) that contains multiple openings and casting channels for a cycle of pour (like first cast), each of the respective openings is located in the same Z plane or elevation to prevent siphoning. Siphoning can result from a height difference between the respective casting channels/openings, leading to uneven slurry flow and potential defects in the final cast solid product. This issue can be effectively mitigated by ensuring that all openings and casting channels for a given filling level are all at the same height or elevation, such that each of the segments 40 or arms 44 has openings and casting channels at the same height or elevation.

Next, as shown in FIG. 1B, terminal ends 60 of the first casting segments 50 of formwork 40 are respectively coupled to anchors 30 so as to anchor the first set of segments 50 to the surface 20. In a compression-only structure, the foot of the structure is fixed to the surface 20 to minimize or prevent any horizontal movement or displacement. This can be achieved through various means, for example, one common approach is to embed the foot of the structure in a concrete foundation that is anchored to the ground using rebar or other reinforcement. The foundation is typically designed to resist the lateral forces generated by the compression load, such as wind or seismic forces, and provide a stable base for the structure to rest on. Another approach is to use a base plate, or a steel plate that is welded or bolted to the bottom of the structure and then anchored to the ground using bolts or other fasteners. The base plate can be designed to resist the compression load and any lateral forces that may be present. In either variation, it is important to ensure that the connection between the foot of the structure and the surface 20 that the structure is sitting on (in case of dome of a building) is strong enough to resist the applied loads and that the foundation or base plate is designed and installed to prevent any movement or deformation of the structure after fabrication.

One or more temporary scaffold supports 32 can be disposed in a vertical orientation between the surface 20 and one or more first holding components 70 to help scaffold/support the set of first casting segments 50 of the formwork 40. The one or more first holding components 70 are disposed beneath select regions on the set of first casting segments 50. The holding components 70 may be shaped and have dimensions to adequately support one or more intermediate points along the first casting segments 50 of the formwork 40.

Notably, as depicted in this embodiment and described herein, the first casting segments 50 may include at least one first opening 90 to a first casting channel 92 that corresponds to a first elevation or height “h₁” (as best seen in FIG. 1D) in fluid communication with the internal open volume 38 of the formwork 40 to be filled with slurry material. However, each segment need not have an opening, as will be appreciated by those of skill in the art. The formwork may have multiple segments that are assembled together to form a larger segment for casting (referred to as a “casting segment”). Here the casting inlet/at least one first opening 90 relates to the number of sequential casting cycles to be conducted and thus, the number of these openings depends on the achievable casting height with respect to hydrostatic pressure for each casting cycle. Thus, while the discussion of various openings and inlets in the context of the embodiments shown and discussed herein (e.g., in FIGS. 1A-1I) is merely representative, it will be appreciated that these may vary or be omitted. In FIG. 1C, the set of second casting segments 52 of formwork 40 are respectively coupled to the set of first casting segments 50. Notably the interface between the various segments 42 of the formwork 40 when they are joined is desirably fluid-tight (e.g., water-tight) and thus sealed. Thus, the formwork 40 segments 42 may be joined together mechanically, as well as chemically (e.g., through chemical welding). For example, formwork segment connections/joint details may be mechanically coupled and/or structurally bonded together. Such a sealed joint may be formed by a friction or interference fit, mechanical coupling or fasteners, application of sealants or sealing tape/sleeves (e.g., metal or plastic sleeves), ultrasonic welding, and the like. For example, suitable formwork segment connections/joint details may include one or more of the following: a compression coupling using sleeves over two connecting segments, male and female configured segments to form a connection therebetween, or other fluid-tight connections, such as a housing over a joint, threaded connections, compression ring connection, gaskets, adhesives, and the like.

While not shown in the figures, it will be appreciated that the formwork may have bleed holes or vacuum ports that may be sealed and unsealed when in use. One or more second holding components 70A are disposed beneath regions the set of second casting segments 52. One or more temporary scaffold supports 32A can be disposed in a vertical orientation between the surface 20 and the second holding components 72A to help scaffold/support the set of second casting segments 52 of the formwork 40. Each of the second casting segments 52 may include at least one second opening 94 to a second casting channel 96 that corresponds to a second elevation or height “h₂” in fluid communication with the internal open volume 38 of the formwork 40 to be filled with slurry material. A difference in the first elevation/height to second elevation/height will be h₂−h₁. As will be appreciated, the location of first openings and first casting channels and second openings and second casting channels and the like within the formwork relate to the casting height per slurry introduction cycle, which is determined based on the formwork's ability to resist the hydrostatic pressure of the slurry being cast. As noted above, if a member/arm of the casting contains multiple casting channels for a cycle of pour (like a first casting step), the openings must be located in the same Z plane (e.g., same elevation across different regions of the open volume 38) to prevent the occurrence of siphoning. Siphoning can result from a height difference between the channel openings, leading to uneven slurry flow and potential defects in the final product. This issue can be effectively mitigated by ensuring that all channel openings are at the same level.

In FIG. 1D, the set of third casting segments 54 of formwork 40 are respectively coupled to the set of second casting segments 52 and serve as one or more upper segments of the additively manufactured formwork 40 and serve to connect each of the members/arms 44 to one another, for example, in a fluid tight manner so that fluid communication is established within the internal open volume 38 of the formwork 40. As shown in FIG. 1D, the third casting segments 54 may not require support by the temporary scaffold supports and thus may omit holding components, although depending on the design of the formwork 40 and structure to be formed, such segments may be designed to be supported by holding components and connected to one or more temporary scaffold supports as will be readily envisioned by those of skill in the art. Each of the third casting segments 54 may include at least one third opening 98 to a third casting channel 100 that corresponds to a third elevation or height “h₃” in fluid communication with the internal open volume 38 of the formwork 40 to be filled with slurry material. A difference in the first elevation/height to third elevation/height will be h₃−h₁, while a difference between the second elevation/height and third elevation/height is h₃−h₂.

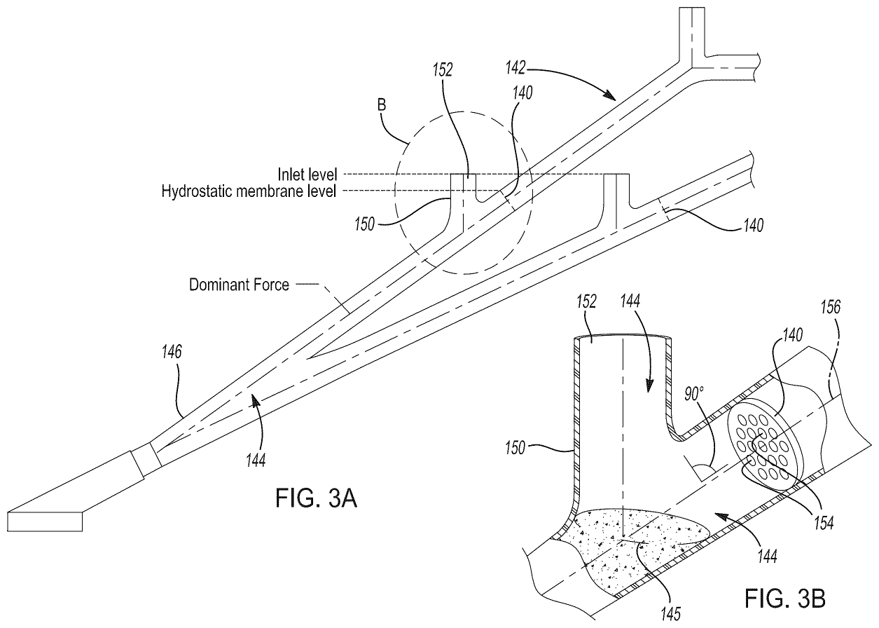

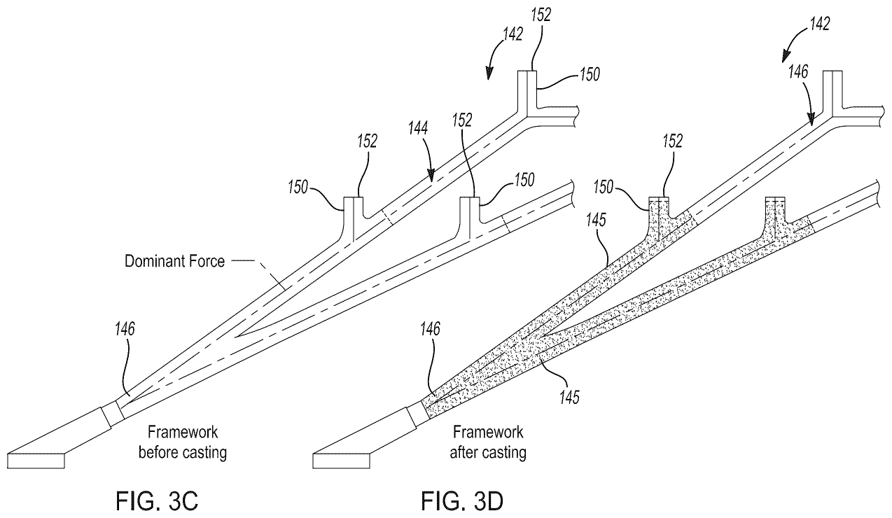

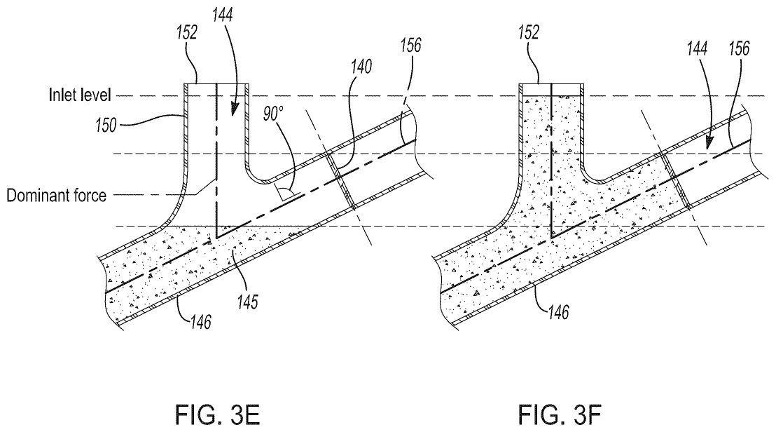

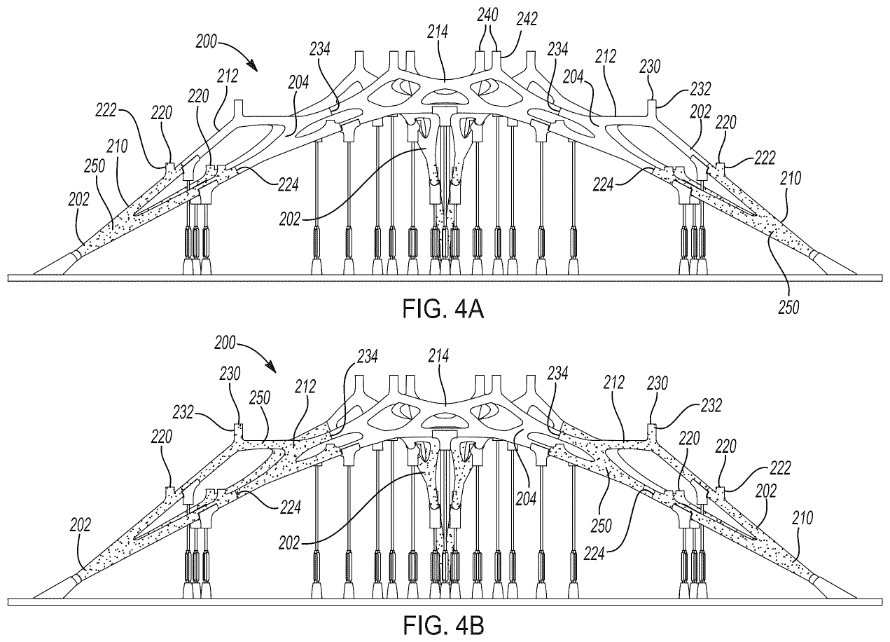

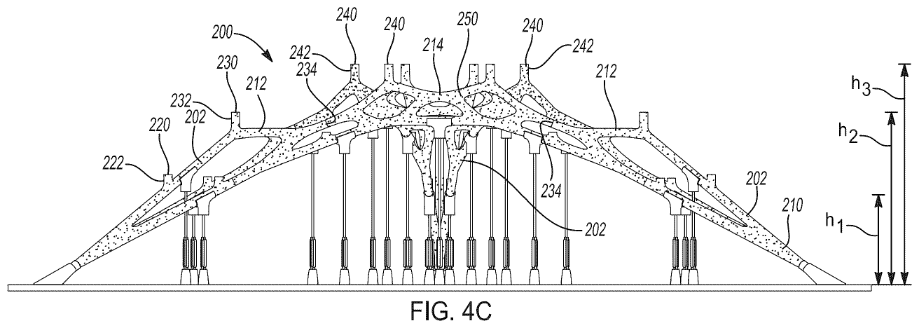

FIGS. 1E-1G generally show the cast-in-place method that includes steps of sequentially adding slurry material to the assembled multi-part lightweight additively manufactured formwork 40 to form a solid compression-based structure. It should be noted that there are distinct approaches to the cast-in-place methods described herein. In the variation shown in FIGS. 1E-1G, a slurry material 110 is introduced into the open volume 38 of the formwork 40 and permitted to settle at each respective level such that the slurry is parallel to the plane of surface 20 below. In such a variation, as will be appreciated by those of skill in the art, supplemental external brackets or supports may be used on the exterior of the formwork 40 to ensure that the cast component does not slide out of the formwork 40 structure as a result of lateral forces during casting. A non-limiting example of select placement of such external braces 122 around the formwork 40 is shown in FIG. 1I. As will be appreciated, placement of such external braces 122 is merely illustrative and non-limiting and may in fact be in various other locations around the formwork. As will be described in further detail below in the context of FIGS. 3A-3F and 4A-4C, in other variations, a slurry material is introduced into the open volume of the formwork and is designed to be retained orthogonally or perpendicularly to internal forces (e.g., imparted by the slurry material) as it solidifies within the formwork, which can help stabilize the formwork without requiring additional external bracing or supports.

In FIG. 1E, a slurry material 110 is introduced into each of the first casting segments 50 via at least one first opening 90 and thus flows through the first casting channel 92 into the open volume 38 of the formwork 40. The slurry material 110 is added in a first amount so that it fills the open volume 38 up to a first level represented by the first elevation/height “h₁.” Notably, the slurry at the first elevation/height “h₁” in this embodiment is generally parallel to the plane of surface 20 below. In concrete structures using the set-on-demand concrete mix as the slurry material, the mix undergoes a chemical reaction to harden and gain strength as required. Further, accelerators known in the art may be added to the slurry material to facilitate faster setting and/or more rapid hardening so that it may physically support sequentially deposited material. The casting methods described herein can be used with other slurry materials, like clay and earth-based materials. In such variations, while it may not be possible to use an accelerator as with cementitious materials, alternative techniques may be used to strengthen and stabilize clay and earth-based materials. For example, one such approach uses soil stabilization techniques, typically involving adding a stabilizing agent, such as lime or cement, to the soil to increase its strength and durability. In summary, while set-on-demand concrete mix may not be directly applicable to clay and earth-based slurry, some alternative techniques and materials can be used to improve their strength and stability on demand.

After the slurry material has set sufficiently within the first casting segments 50 of the formwork 40 sufficient to support additional layers of slurry material, additional slurry material may then be introduced into the open volume 38 of the additively manufactured formwork 40 via one or more additional introduction steps, as shown in FIG. 1F. An additional second amount of slurry material 110 is introduced into each of the second casting segments 52 via at the second openings 94 and thus flows through the second casting channels 96 into the open volume 38 of the formwork 40. The slurry material 110 is added over the set or at least partially hardened material at the first level in a second amount so that it fills the open volume 38 up to a second level represented by the second elevation/height “h₂.” In this manner, the sequentially deposited second amount of slurry material spreads over and likewise sets and/or hardens and eventually forms a monolithic solid structure with the first amount of slurry below it. Notably, the slurry at the second elevation/height “h₂” in this embodiment is generally parallel to the place of surface 20 below. In certain variations, the solid structure may be completed with two sequential casting steps and will not require additional slurry material. In other variations, additional casting steps may be conducted to fill the open volume 38 of the formwork 40 with slurry material to form the solid structure.

As shown in FIG. 1G, a third non-limiting casting step may be conducted by introducing additional slurry material. After the slurry material 110 has set within the second casting segments 52 of the formwork 40 sufficient to support additional layers of slurry material, yet more additional slurry material may then be introduced into the open volume 38 of the additively manufactured formwork 40 via one or more additional introduction steps, as shown in FIG. 1G. An additional second amount of slurry material 110 is introduced into each of the third casting segments 54 at the third openings 98 and thus flows through the third casting channels 100 into the remaining open volume 38 of the formwork 40. The slurry material 110 is added in a third amount over the set or at least partially hardened material corresponding to the second elevation/second level so that it fills the open volume 38 up to a third level represented by the third elevation/height “h₃.” In this manner, the sequentially deposited third amount of slurry material spreads over and likewise sets and/or hardens and eventually forms a third layer of the monolithic solid structure with the second amount of slurry deposited as a second layer directly below it.

In FIG. 1H, the slurry material is permitted to fully solidify by hardening and/or setting into the solid compression-based structure 120, which may be a duration of minutes up to 28 days or longer, depending on the volume and type of slurry material used (including setting properties of the slurry material), and the size and design of the compression-based structure formed. Notably, the one or more temporary scaffold supports 32, 32A remain in place supporting the lightweight additively manufactured formwork 40 and the hardening slurry material 110 contained therein. In certain aspects, the one or more temporary scaffold supports 32, 32A are not removed until after all the open volume 38 in the formwork is filled with slurry material, ensuring the entire structure is in a state of equilibrium where the structure is in compression.

In FIG. 1I, the slurry material has solidified into the solid compression-based structure 120 having three arms 44. After full solidification of the compression-based structure 120, the one or more temporary scaffold supports 32, 32A (shown in FIG. 1H) may be removed along with the first and second holder components 70, 70A (shown in FIG. 1H). The additively manufactured formwork 40 may be left intact around the solid compression-based structure 120 as formed or may be removed.

Additional processing and finishing of the structure may also be done, for example, to remove sprues remaining within the casting channels and to smooth out the surface. As shown in FIGS. 1A-1I, the methods and additively manufactured formwork provided by various aspects of the present disclosure can enable the formation of complex designs of compression-based shapes.

In this manner, the present disclosure provides various advantages, including a significant reduction in transportation costs, by eliminating the need to transport prefabricated masonry or concrete parts, which is costly and contributes to carbon dioxide (CO₂) emissions. Additionally, building parts often break or crack during transportation and assembly, making them challenging to handle, leading to damage and extra cost. However, with the present technology, using a lightweight 3D printed formwork, such as plastic, is less expensive to transport and easier to handle during assembly due to its weight, minimizing the risk and cost of damages during the transportation and assembly of lightweight formwork. Further, the additively manufactured/3D printed formwork can be reused and/or recycled.

Further, the methods of making the compression-based structures provides for a significant reduction in scaffolding structure. Construction of compression-only structures using components such as brick, pre-cut stones, or 3D-printed concrete blocks requires heavy scaffolding structures to support the weight of building parts during construction, which results in higher cost of construction and limited accessibility. The extensive scaffolding required is at least in part due to use of brick or stones that are small in size, where the scaffolding (e.g., a wood structure) that holds them all in place during construction. With the present technology, the additively manufactured/3D-printed formwork does not require heavy scaffolding due to being lightweight and formed of large segments (because the 3D printed part can be produced in large sizes that are much larger than bricks and stones). Rather, minimal vertical scaffold structures can be used. Further, the present technology increases the accessibility and affordability of constructing compression-based structures by enabling additive manufacturing/3D printing of formwork anywhere, including at the construction site.

In one variation, a method of making a compression-based structure may comprise introducing a first amount of a slurry material into at least one first opening of a first casting channel in fluid communication with an internal open volume of an additively manufactured formwork. The internal open volume of the formwork defines the compression-based structure that includes at least two supporting portions and the introducing the first amount of slurry fills the open volume to a first level. The additively manufactured formwork is supported by one or more temporary scaffold supports extending from a surface. The method includes further introducing an additional amount of slurry into at least one additional opening of an additional casting channel of the formwork that is in fluid communication with the open volume so that the additional amount of slurry fills the open volume to a second level above the first level. The slurry solidifies to form the compression-based structure within the formwork on the surface. The at least one additional opening comprises a second opening in a second casting channel of the formwork that is in fluid communication with and connects to the open volume and a third opening in a third casting channel of the formwork that is in fluid communication with and connects to the open volume. The introducing further comprises introducing at least a second amount of the slurry material into the second opening of the second casting channel of the formwork, so that the second amount of the slurry material fills the open volume to a second level above the first level. The introducing also comprises introducing at least a third amount of the slurry material into the third opening of the third casting channel of the formwork, so that the third amount of the slurry material fills the open volume to a third level above the second level.

In certain variations, the solid compression-based structure is monolithic but formed by multiple sequential deposition solid layers, for example, two or three or more adhered solid segments corresponding to the first level, the second level, and optional third or greater level(s).

In certain aspects, the open volume of the formwork defines the compression-based structure that includes at least three supporting portions or members (e.g., arms). The three arm/leg design is only a representative example, however, the structure may have 100 or more arms/legs or may have no legs in the case of a dome structure.

The method may also include introducing the first amount of the slurry material by introducing it into at least two distinct first openings of two distinct first casting channels in fluid communication with the open volume so the first amount of slurry fills the open volume to a first level. For example, each respective arm of the compression-based structure may have its own first openings and its own associated first casting channel and the slurry material is introduced into each respective first opening and first casting channel. The further introducing the additional amount of slurry may likewise comprise introducing additional slurry into at least two additional openings of two additional casting channels in fluid communication with the open volume so that the additional amount of slurry fills the open volume to the second level above the first level.

In certain variations, the compression-based structure defines at least one arch, dome, vault, shell, bridge, slab, ceiling, beam, or ribbed structure. Some compression-based structures may be designed for ribbed structures, where the formwork features or defines ribs. Other compression-based structures may be designed for thin shell structures, by way of non-limiting example, Felix Candela's concrete shell, with the formwork resembling a shell with cavities. Further, the present disclosure contemplates hybrid versions that combine features of both shell and rib structures.

In certain other aspects, alternative additively manufactured formwork may be used in such sequential casting methods. As noted above, in certain variations, it is advantageous that the slurry material solidifies within the formwork in an orientation that is orthogonal or perpendicular to dominant flow of compressive forces (e.g., imparted by the slurry material) at one or more elevations or levels. As will be described further herein, respective segments of the formwork may define a longitudinal axis within the open volume that corresponds to such compressive forces. In one variation, the formwork further comprises at least one hydrostatic membrane disposed in an open volume of the formwork. The hydrostatic membrane may be oriented orthogonal or perpendicular to the longitudinal axis corresponding to the dominant compressive forces that will occur within the segment. Thus, hydrostatic membranes may be introduced into the open volume at different elevations/segments of the formwork to ensure each segment of cast concrete supports the weight above it and transfers the load to the next one, distributing the forces throughout the solid structure. The hydrostatic membrane thus allows the cold joints between the sequentially casted segments to be perpendicular to the dominant flow of compressive forces and not parallel to the ground in these variations. Therefore, in certain aspects, a directionality of the joint system in the formwork corresponds to and is orthogonal to a direction of dominant flow of internal forces in the open volume.

In certain aspects, the number of hydrostatic membranes disposed in the open volume of the formwork may be equal to a total number of casting cycles multiplied by a number of supporting portions (e.g., arms or branches) at each casting level/stage. After each sequential casting step, the cast portion of the structure is turned to an element with cold joints. In this manner, the next sequential casting does not need to create a bond with the previous cast segment. The hydrostatic membranes are introduced to ensure that each segment of cast concrete supports the weight above it and transfers the load to the next one, distributing the forces throughout the cast structure. Thus, each hydrostatic membrane prevents the slurry material from passing beyond a set elevation and guides the angle of the finish interface for every sequence of cast material. The hydrostatic membranes are thus aligned perpendicular to the dominant flow of compressive forces and are positioned at the maximum casting height per cycle to ensure that the respective height(s) of the membranes align with the height of casting opening as shown in FIG. 3A, discussed herein.

By way of example, FIGS. 3A-3F show hydrostatic membranes 140 incorporated into a multi-segment additively manufactured lightweight formwork 142 according to certain variations of the present disclosure. FIG. 3A shows directions of dominant force within an internal open volume 144 corresponding to compressive forces introduced by slurry material 145 (not shown in FIG. 3A but shown in FIG. 3B) in a representative segment 146 of formwork 142. Notably, the dominant force generally corresponds to a longitudinal axis of the open volume 144 in the segment 146 where the hydrostatic membrane 140 is disposed. FIG. 3B shows a magnified view of FIG. 3A in a region of the segment 146 showing a casting channel 150 with an inlet 152 and the hydrostatic membrane 140 disposed in the open volume 144. The hydrostatic membrane 140 has at least one vent, shown in FIG. 3B as a plurality of openings 154. The hydrostatic membrane may have a thickness of greater than or equal to about 0.5 mm to less than or equal to about 2 mm, for example, about 1 mm and a diameter that corresponds to a diameter of the segment in which it is to be disposed. For example, a diameter of the formwork segment may be of the greater than or equal to about 30 mm to less than or equal to about 90 mm, for example, so that a diameter of the hydrostatic membrane is sized to fit within such a diameter and thus likewise ranges from greater than or equal to about 30 mm to less than or equal to about 90 mm. In certain variations, the hydrostatic membrane may be made of a polymeric material, for example, it may be formed via additive manufacturing/3D printing and may be selected to be the same material as that forming the formwork as discussed above, such as PLA, PETG, resin, and the like. In other variations, the hydrostatic membrane may be prefabricated and optionally formed from a non-additively manufacturing process. In this manner, the hydrostatic membrane could be added to the 3D-printed formwork as a plate inserted within the 3D printed formwork. Suitable materials may include polymeric/polymeric materials, rubber, metal, and the like.

As noted above, the hydrostatic membrane may have one or more holes/openings 154 that act like a vent to release air during casting. The number and size of openings permit air to vent so that trapped air is eliminated while casting but stops the slurry material from passing/leaking to the next casting segment.

Likewise, an orientation or alignment of the hydrostatic membrane 140 is substantially perpendicular or orthogonal to a direction of the dominant compressive forces that also corresponds to a longitudinal axis 156 defined by the open volume 144 of the segment 146 in the region. By way of example, a substantially perpendicular orientation may be understood to mean that a major plane of the hydrostatic membrane 140 intersects with or forms an angle with respect to the longitudinal axis 156 that is about 90°±15°, optionally about 90°±10°, optionally about 90°±5°, and in certain aspects, optionally about 90°±3°. The interlocking nature of adjacent cast sections provides stability and allows the structure to withstand compression forces without collapsing. By enhancing the bonding and joint strength between sequentially cast sections of the solid compression-based structure, the faces of components in compression are perpendicular to the dominant flow of compressive forces. In this manner, the cold joints at interfaces between the sequentially casted segments are perpendicular to the dominant flow of compressive forces. This is achieved by integrating the hydrostatic membranes 140, which when aligned substantially perpendicular to the dominant flow of compressive forces within the open volume of the formwork. Further, the hydrostatic membranes 140 are positioned at a maximum casting height per cycle. For example, as shown in FIGS. 3A and 3F, the hydrostatic membrane 140 is placed at an elevation or level that is below a level of the inlet 152 to ensure that the slurry will come into contact with the hydrostatic membrane 140 after it is introduced into open volume 144 during the casting cycle via inlet 152 and casting channel 150.

FIGS. 3C and 3D show the segment 146 of formwork 142 with the hydrostatic membrane 140 before adding a first amount of slurry (FIG. 3C) and after adding the first amount of slurry 145 (FIG. 3D). FIG. 3E is a magnified view of a region of the segment 146 showing the casting channel 150 with the inlet 152 and hydrostatic membrane 140 disposed in the open volume 144 where the slurry 145 initially fills the open volume 144 at a level parallel to ground. Whereas in FIG. 3F, the same region after the slurry 145 has been filled to a first level shows that the slurry 145 fully contacts the hydrostatic membrane 140 disposed below an inlet level of inlet 152 so that the slurry 145 defines a surface that is perpendicular to the longitudinal axis 156 to ensures that cold joints between sequentially cast sections are perpendicular to the dominant flow of compressive forces while casting.

FIGS. 4A-4C generally show the cast-in-place method that includes steps of sequentially adding slurry material to the assembled multi-part lightweight additively manufactured formwork 200 having a plurality of hydrostatic membranes in an open volume 204, as described further herein. The formwork 200 has three distinct supporting sections or members (e.g., arms 202) and includes a set of first casting segments 210 that will define a first level of slurry filling, a set of second casting segments 212 that will define a second level of slurry filling above the first level, and a set of third casting segments 214 that will define a third level of slurry filling above the first and second levels of slurry.

Each of the first casting segments 210 may include at least one first opening 220 to a first casting channel 222 that corresponds to a first elevation or height “h₁” in fluid communication with the internal open volume 204 of the formwork 200 to be filled with slurry material. Each of the first casting segments 210 also includes first hydrostatic membranes 224.

Each of the second casting segments 212 may include at least one second opening 230 to a second casting channel 232 that corresponds to a second elevation or height “h₂” in fluid communication with the internal open volume 204 of the formwork 200 to be filled with slurry material. Each of the second casting segments 212 also includes second hydrostatic membranes 234.

Each of the third casting segments 214 may include at least one third opening 240 to a third casting channel 242 that corresponds to a third elevation or height “h₃” in fluid communication with the internal open volume 204 of the formwork 200 to be filled with slurry material.

In FIG. 4A, a slurry material 250 is introduced into each of the first casting segments 210 via at least one first opening 220 and thus flows through the first casting channel 222 into the open volume 204 of the formwork 204. The slurry material 250 is added in a first amount so that it fills the open volume 204 up to a first level represented by the first elevation/height “h₁.” Notably, the slurry 250 at the first elevation/height “h₁” in this embodiment aligns with the hydrostatic membrane 224 and thus is generally perpendicular or orthogonal to a major longitudinal axis in the first segment 210. This provides an advantageous perpendicular cold joint interface between the first segment 210 and the second segment 212.

After the slurry material 250 has set sufficiently within the first casting segments 210 of the formwork 200 sufficient to support additional layers of slurry material, additional slurry material may then be introduced into the open volume 204 of the additively manufactured formwork 200 via one or more additional introduction steps, as shown in FIG. 4B. An additional second amount of slurry material 250 is introduced into each of the second casting segments 212 via at the second openings 230 and thus flows through the second casting channels 232 into the open volume 204 of the formwork 200. The slurry material 250 is added over the set or at least partially hardened material at the first level in a second amount so that it fills the open volume 204 up to a second level represented by the second elevation/height “h₂.” In this manner, the sequentially deposited second amount of slurry material is disposed over and likewise sets and/or hardens and eventually forms a monolithic solid structure with the first amount of slurry below it. Notably, the slurry at the second elevation/height “h₂” in this embodiment aligns with the hydrostatic membrane 234 and thus is generally perpendicular or orthogonal to a major longitudinal axis in the second segment 220. This provides an advantageous perpendicular cold joint interface between the second segment 212 and the third segment 214. In certain variations, the solid structure may be completed with two sequential casting steps and will not require additional slurry material. In other variations, additional casting steps may be conducted to fill the open volume 204 of the formwork 200 with slurry material 250 to form the solid structure.

As shown in FIG. 4C, a third non-limiting casting step may be conducted by introducing additional slurry material 250. After the slurry material 250 has set within the second casting segments 212 of the formwork 200 sufficient to support additional layers of slurry material, yet more additional slurry material 250 may then be introduced into the open volume 204 of the additively manufactured formwork 200 via one or more additional introduction steps, as shown in FIG. 4C. An additional second amount of slurry material 250 is introduced into each of the third casting segments 214 at the third openings 240 and thus flows through the third casting channels 242 into the remaining open volume 204 of the formwork 200. The slurry material 250 is added in a third amount over the set or at least partially hardened material corresponding to the second elevation/second level so that it fills the open volume 204 up to a third level represented by the third elevation/height “h₃.” In this manner, the sequentially deposited third amount of slurry material spreads over and likewise sets and/or hardens and eventually forms a third layer of the monolithic solid structure with the second amount of slurry deposited as a second layer directly below it.

Thus, in certain aspects, the present disclosure contemplates methods of making a compression-based structure that comprises introducing a first amount of a slurry material into at least one first opening of a first casting channel in fluid communication with an open volume of an additively manufactured formwork. The additively manufactured formwork is supported by one or more scaffold supports. The open volume of the formwork defines the compression-based structure and the introducing the first amount of slurry fills the open volume to a first level. The method further comprises further introducing an additional amount of slurry material into at least one additional opening of an additional casting channel of the formwork that is in fluid communication with the open volume so that the additional amount of slurry material fills the open volume to a second level above the first level. The slurry material solidifies to form the compression-based structure within the formwork.

In certain aspects, the formwork further comprises at least one hydrostatic membrane disposed in the open volume of the formwork lower than a height of the at least one first opening of the first casting channel. The open volume of the framework defines a longitudinal axis and the at least one hydrostatic membrane is disposed in the open volume in an orientation substantially orthogonal to the longitudinal axis. In this manner, the at least one hydrostatic membrane defines an interface between the first level and the second level, where a cold joint between the first level and second level exists.

In certain variations, the at least one hydrostatic membrane comprises at least one vent that permits gas, vapor, or the like to escape or otherwise pass through while the slurry is being poured into the open volume of the formwork. However, the slurry is retained by the hydrostatic membrane.

In certain further variations, the at least one additional opening comprises a second opening in a second casting channel of the formwork that is in fluid communication with and connects to the open volume and a third opening in a third casting channel of the formwork that is in fluid communication with and connects to the open volume. At least a second amount of the slurry material is introduced into the second opening of the second casting channel of the formwork, so that the second amount of the slurry material fills the open volume to a second level above the first level. Further, at least a third amount of the slurry material is introduced into the third opening of the third casting channel of the formwork, so that the third amount of the slurry material fills the open volume to a third level above the second level. The formwork further comprises at least one first hydrostatic membrane disposed in the open volume of the formwork lower than a first height of the at least one first opening of the first casting channel and at least one second hydrostatic membrane disposed in the open volume of the formwork lower than a second height of the at least one second opening of the second casting channel. In certain aspects, the open volume defines a longitudinal axis and each of the at least one first hydrostatic membrane and the at least one second hydrostatic membrane is disposed in the open volume in an orientation substantially orthogonal to the longitudinal axis (e.g., corresponding to a direction of local dominant compressive forces). The at least one first hydrostatic membrane defines an interface between the first level and the second level and the at least one second hydrostatic membrane defines an interface between the second level and the third level. The at least one first hydrostatic membrane and the at least one second hydrostatic membrane each comprise at least one vent.

Further, the method may include introducing the first amount of the slurry material into at least two distinct first openings of two distinct first casting channels in fluid communication with the open volume so the first amount of slurry material fills the open volume to a first level and the further introducing the additional amount of slurry material comprises introducing the additional amount of slurry material into at least two additional openings of two additional casting channels in fluid communication with the open volume so that the additional amount of slurry fills the open volume to the second level above the first level. In such a variation, the formwork may further comprise at least two first hydrostatic membranes disposed in the open volume of the formwork lower than a first height of the at least two distinct first openings of the two distinct first casting channels. The formwork may also further comprise at least two second hydrostatic membranes disposed in the open volume of the formwork lower than a second height of the at least two distinct second openings of the two distinct second casting channels.

In certain aspects, the compression-based structure formed by sequential casting methods into an additively manufactured formwork contemplated by the present disclosure is free of any metal reinforcements, such as metal reinforcements, like steel rebar. However, in other variations, the compression-based structure formed by sequential casting methods into an additively manufactured formwork contemplated by the present disclosure comprises at least one metal reinforcement, e.g., metal rebar reinforcement, such as steel rebar or other metal reinforcement. Such a metal reinforcement may be used to carry tension within concrete. In certain applications, for example, for larger load-bearing structures, metal reinforcements may be included in the load-bearing compression-based structure.

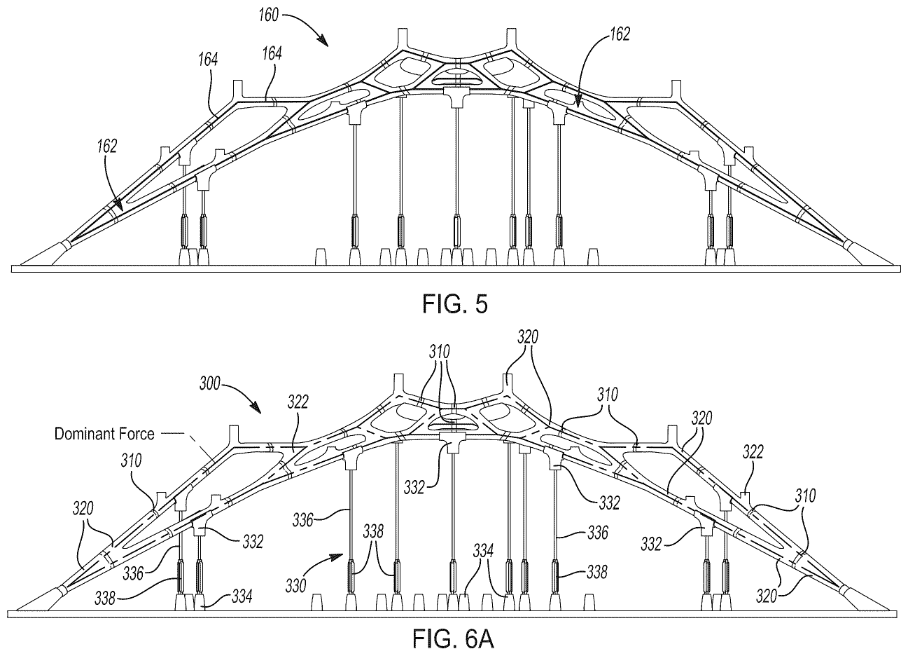

FIG. 5 shows a multi-part lightweight additively manufactured formwork 160 on a site where a compression-based solid structure having tensioning or reinforcement components, more specifically, metal reinforcements is to be formed. After assembly, the formwork 160 has an exterior shell and defines an open volume 162. The open volume 162 further comprises a plurality of metal reinforcements 164 disposed therein, which may together define a rebar system, for example. The plurality of metal reinforcements 164 may generally extend parallel to/along a longitudinal axis of the open volume and thus correspond to the dominant compressive forces described previously in the context of FIGS. 3A-3F. The plurality of metal reinforcements 162 may or may not be connected to one another via a coupling, mechanical fastener, and the like. After the open volume 162 in the formwork 160 is filled with slurry material (not shown), the slurry will fill around the metal reinforcements 164 and after solidification, will form the solid compression-based structure having metal reinforcements disposed therein. By way of non-limiting example, sequentially casting by use of such ultra-lightweight compression-only formwork according to certain aspects of the present disclosure is applicable to various structures and components like slabs, bridges, floor systems, ceilings, columns, furniture, or any compression-only pavilion/structure with or without tension members and with or without a rebar system.

Further, the additively manufactured formwork may be a lightweight structure that comprises a polymeric material or polymer, as described above. Additionally, the methods described herein can be extended to use with any lightweight prefabricated formwork, for example, any lightweight formwork or any 3D printed formwork that can be used for casting concrete, including 3D printing of biodegradable material, 3D printing wood formwork, and the like. In certain variations, a thickness of a wall of the lightweight formwork may be an average thickness of greater than or equal to about 1 mm to less than or equal to about 5 mm, for example, about 1.5 mm. For example, a thickness of the wall of the formwork can correspond to the hydrostatic pressure, the number of casting cycles desired, and the geometry of the rib. In one non-limiting example, an embodiment that is 700 mm long may have a wall thickness of about 1.5 mm where 3 casting cycles are used.

In certain aspects, introducing the additional amount of slurry after the first amount of slurry (or the preceding amount of slurry introduced into the formwork) occurs after the slurry material has set. The setting time depends on the slurry material mix. For a typical cementitious concrete material without any accelerators, setting typically occurs within about a day (24 hours). However, if a set-on-demand or rapid setting slurry material is used, depending on the preselected composition of the slurry material, the setting time can be from 0 minutes (no waiting time until the next round of slurry material is introduced) to less than an hour, for example, greater than or equal to about 5 minutes to less than or equal to about 40 minutes, optionally greater than or equal to about 10 minutes to less than or equal to about 30 minutes. In certain aspects, introducing the additional amount of slurry after the first amount of slurry (or the preceding amount of slurry introduced into the formwork) occurs at greater than or equal to about 1 minute to less than or equal to about 24 hours after the introducing of the first or preceding amount of slurry.

In certain variations, the slurry material comprises a material selected from the group consisting of: cementitious-based materials, clay, earth-based materials, dirt, bio-material, masonry, starch, and combinations thereof. The slurry may be a liquid or semi-liquid that is pumpable or flows into the structure. In certain aspects, the slurry material may be a cementitious composition, that is pumpable and flows in a first state, but after hydraulic setting and reaction proceeds, the cementitious composition is in a hardened state. In various aspects, the cementitious composition optionally comprises a cementitious material, which may include a cement or pozzolan. In certain variations, the cementitious composition comprises Portland cement, an aggregate, such as a fine aggregate, water, and other typical ingredients known to those of skill in the art for cementitious compositions, such as fly ash, plasticizers, accelerators, and the like.

In alternative aspects, the present technology may include a slurry that includes clay, earth-based materials, starch, silicas, geo-polymers, liquid-polymers, and the like. The material has a viscosity such that it can be pumped. A reinforced composite material may be formed with a slurry precursor having low viscosity that is pumpable or otherwise flows. Further, an accelerator may be added to allow for an on-demand setting. In certain aspects, the slurry material comprises an accelerator. In certain aspects, the slurry material may be a “set-on-demand,” meaning the mixture may include an accelerator or an additive to speed the setting of material. Such a set-on-demand slurry material may be especially advantageous when casting the entire structure within a limited time frame. Alternatively, an accelerator or additive may be omitted, such that the setting occurs during a typical timeframe, which may necessitate waiting relatively longer for the slurry material to set for a certain period (e.g., such as a day) before casting the subsequent round.

A Portland cement typically comprises inorganic compounds, such as dicalcium silicate (C₂S or 2Cao.SiO₂), tricalcium silicate (C₃S or 3CaO.SiO₂), tricalcium aluminate (C₃A or 3CaO.Al₂O₃), and tetracalcium aluminoferrite (C₄AF or 4CaO.Al₂O₃.Fe₂O₃), which may be hydrated. Commercially available Portland cement often includes additives, such as gypsum (calcium sulfate) that serves as a set retardant, and pozzolans, like fly ash and ground granulated blast furnace slags (GGBFS), that can react with calcium hydroxide and water to form calcium silicate hydrates or calcium aluminate hydrates. When pozzolans are added to Portland cement, they are considered to be blended cements. ASTM, International Test C 150 called the “Standard Specification for Portland Cement” provides eight types of ordinary Portland cement for different applications, namely: Types I, IA, II, IIA, III, IIIA, IV, and V. In certain non-limiting aspects, the Portland cement used in the cementitious composition is Type I. The Portland cement may be present in the cementitious composition at greater than or equal to about 50 mass/weight % to less than or equal to about 98 mass % of the total mass of cementitious binder components, optionally at greater than or equal to about 60 mass/weight % to less than or equal to about 90 mass % of the total mass of cementitious binder components, and in certain variations, optionally at about 72% by mass of the total mass of the cementitious binder components.

In certain variations, the cementitious composition further comprises a fly ash that can be added to the cementitious composition and serves as a pozzolan/cementitious material. Fly ash is an industrial byproduct, for example, collected from effluent of a coal burning boiler unit. It can be used as a substitute for a portion of the Portland cement to reduce energy consumption required to form the overall product and increase the environmental friendliness of the cementitious composition, while contributing to the cementitious properties of the matrix/binder system of the concrete composite. In one variation, the fly ash may be a Class F fly ash as designated by ASTM C618, which is formed from combustion of anthracite and/or bituminous coals. ASTM C618 requires that Class F fly ash contain at least 70% pozzolanic compounds (silica oxide, alumina oxide, and iron oxide). The fly ash may be present in the cementitious composition at 0 mass/weight % to less than or equal to about 45 mass % of the total mass of cementitious binder components, optionally at 0 mass % to less than or equal to about 35 mass % of the total mass of cementitious binder components, an in certain aspects, optionally at about 23 mass % of the total mass of cementitious binder components. In other aspects, the fly ash may be present in the cementitious composition at 0 mass % to less than or equal to about 25 mass % of the total cementitious composition.

The cementitious composition may also include a fine aggregate, such as an inert sand or inert finely crushed stone. Fine aggregates may have a particle size distribution having approximately 95% passing on a 9.5 mm sieve (⅜ inch sieve). In certain variations, the fine aggregate is sand. The solid aggregate is distributed within the cementitious matrix to form a composite. In certain variations, the aggregate may be substantially homogeneously distributed within the cementitious composite (e.g., concrete) that is formed. The fine aggregate may comprise sand that has an average particle size of less than or equal to about 2 mm. In one non-limiting variation, the aggregate may be an F-75 silica or quartz sand commercially available from U.S. Silica. The fine aggregate may be present in the cementitious composition at greater than or equal to about 20 mass/weight % to less than or equal to about 65 mass % of the total mass of cementitious binder components, optionally at greater than or equal to about 30 mass/weight % to less than or equal to about 60 mass % of the total mass of cementitious binder components, and in certain variations, optionally at about 45 mass % of the total mass of cementitious binder components.

The cementitious composition may also include a high range water reducing agent (HRWRA), also known as a plasticizer/superplasticizer. Inclusion of the HRWRA can serve to reduce water content needed in the cementitious composition by about 10% to about 30%. The HRWRA can create high fluidity with good flowability properties for the sprayable cementitious composition, contributing to making the cementitious composition suitable for spraying via additive manufacturing by helping to eliminate the need for any vibration or compaction after deposition. An example of a suitable HRWRA is a low viscosity polycarboxlate based high-range water-reducing admixture commercially available from W.R. Grace as ADVA® 190. The HRWRA may be present in the cementitious composition at greater than or equal to about 0.3 mass/weight % to less than or equal to about 1.5 mass % of the total mass of cementitious binder components.

Water is also included in the slurry, such as a cementitious composition. A mass ratio of water to cementitious or other binder components (e.g., Portland cement, and any other pozzolanic materials, like fly ash) may be greater than or equal to about 0.2 to less than or equal to about 0.55. In one variation, a mass ratio of water to cementitious binder components is about 0.43. Water temperature can be used to intentionally manipulate the fresh state properties of a particular cementitious material composition. Water temperature affects fresh state rheological properties due to the accelerated activation of pozzolanic reactions of the cementitious materials. Water may be present in the cementitious composition at greater than or equal to about 10 mass % to less than or equal to about 35 mass % of the total cementitious composition. In one variation, the water may be present at about 20 to about 21% by mass of the total composition (e.g., about 20.7%).

In certain aspects, the additively manufactured formwork for sequential casting methods to form compression-based structures, may involve a design process having two major steps. First, the design of the compression-only structure through the computational form-finding method. Second, the formwork system design informed by structural and casting logic.

By way of example, form-finding of compression-only structures may be conducted as follows, by way of non-limiting example. 3D Graphic Statics (3DGS) may be used as a form-finding method to generate a compression-only structure as the first step of the design process. This method is a three-dimensional extension of Graphic Statics (GS) principles in three-dimensional (3D) space. GS is a graphical methodology of solving the forces acting in equilibrium on a rigid structure by representing forces as vectors or polygons. 3DGS is utilized to derive 3D funicular structural lines by subdividing force polyhedrons based on reciprocal polyhedral diagrams (comprising edges and vertices). With geometrically linked force and form diagrams, this approach permits alterations in support positions, magnitude and angle of applied forces, and their overall distribution.

While 3D Graphic Statics (3DGS) facilitates the exploration of various spatial funicular geometries, it does not incorporate material properties into the form-finding process. Usually, the form diagram, made of edges and vertices, is translated into a compression-only form based on the material's geometric properties. Here, a computational algorithm was developed that would translate the form diagram (edges and vertex diagram) to a representation of concrete structure through the parametric choice of the “profile cross-section.”

Formwork System Design Informed by Structural and Casting Logics. This embodiment uses an additive manufacturing technique, namely stereolithography 3D Printing (SLA) method, to fabricate the ultra-lightweight formwork. SLA uses a low-powered laser to harden a liquid resin contained in a reservoir to create the desired 3D geometry. SLA printing was chosen for this example based on its ability to generate high-quality surface finishing and intricate details and uphold strict tolerances necessary for the formwork joinery system and scaffolding. Enabling on-site 3D printing of formwork, including at the construction site, also enhances the accessibility and affordability of constructing compression-only structures. An important factor in designing a successful 3D printed formwork is overcoming the hydrostatic pressure that arises during the casting process. Hydrostatic pressure (P) is a lateral pressure exerted by fluid concrete to the formwork. It is determined by the fluid concrete's height and density, as shown in Equation (1):

$$P = ρ \times g \times h \qquad ( 1 )$$

where, P=lateral pressure/hydrostatic pressure in N/m², ρ=density of concrete in Kg/m³, g=gravitational force/acceleration in m/s², and h=height of the fluid or plastic concrete in the cast form in m.

As the height of the fluid concrete increases during casting, the hydrostatic pressure exerted on the formwork increases. To mitigate formwork failure due to excess hydrostatic pressure, in various aspects, the present disclosure contemplates the methods of Sequential Casting (SC) of concrete described above. As noted previously, the SC method involves staggered pouring cycles with timed intervals to allow the cast material to set. This approach involves filling the formwork with a liquid slurry material (e.g., concrete), allowing sufficient setting time, proceeding with the next section's pour, and consequently forming cold joints between each casting cycle. Therefore, the number of casting cycles depends on the height value from the above equation. In this method, the casting height was determined by performing a series of mechanical tests on the designed formwork samples to determine the lateral pressure (representing the hydrostatic pressure (P)) it could withstand. Subsequently, this empirically measured hydrostatic pressure is used to calculate the appropriate SC height that the formwork requires. These tests further inform the refinement of the formwork design and iterations.

The following formwork features are introduced and developed to facilitate sequential casting. These features are designed considering the concrete casting constraints (e.g., flowability, the height of the casting point in relation to hydrostatic pressure) and structural parameters.

As described above, casting inlets connected to a casting channel are introduced to the formwork to enable SC into the cavity of the assembled compression-only formwork. The placement and height of these inlets within the formwork depend on the achievable casting height with respect to hydrostatic pressure for each casting cycle. The formwork has numerous casting inlets for each pouring cycle. The inlet openings are strategically located on the same Z plane or elevation, which enables the concrete to flow through the interconnected channels, filling each segment adequately until complete saturation is achieved during the designated casting cycle.

In certain variations, hydrostatic membranes are introduced in the open volume of the formwork to ensure each segment of cast concrete supports the weight above it and transfers the load to the next one, distributing the forces throughout the structure. The interlocking nature of adjacent cast sections provides stability and allows the structure to withstand compression forces without collapsing. The cold joints between the sequentially cast segments are designed to be perpendicular to the dominant flow of compressive forces. This is achieved by integrating hydrostatic membranes as described above, which are aligned perpendicular to the dominant flow of compressive forces and are positioned at the maximum casting height per cycle. These membranes feature small openings that permit venting during the casting process.

Further, to attain a strong formwork structure, different formwork thicknesses are assessed in relation to formwork material and hydrostatic pressure using physical tests and prototyping. An algorithm is developed that would allow parametric adjustment of formwork thickness.

A materialization process represents the second phase of the computational workflow, focusing on formwork discretization, assembly, and scaffolding based on the fabrication constraints.

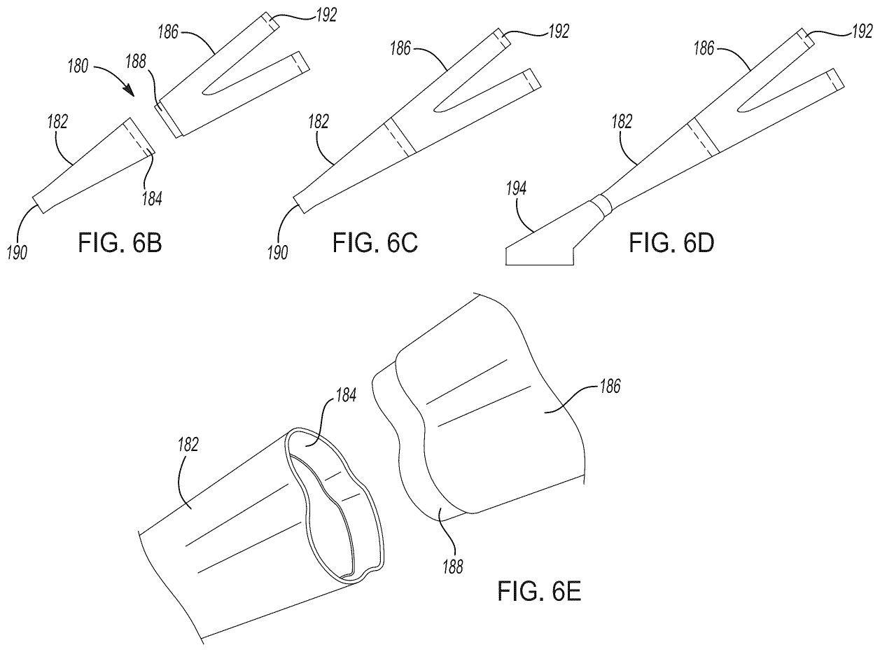

Formwork Discretization is performed. The size of the formwork segments directly correlates with the build volume of the 3D printer. To meet these fabrication constraints, the overall design of the formwork is discretized into segments. The cutting plane of these segments is perpendicular to the direction of the dominant compressive forces to preserve the structural integrity of the formwork and ensure these formwork segments are in compression once assembled. An algorithm is developed to automatically discretize the formwork based on the bed volume of 3D printer input. SLA 3D Printing of a highly complex, detailed, and ultra-thin formwork is done using an ABS-like resin. This fabrication method enables the 3D printing of sophisticated interlocking joints for the formwork segments at a minimum layer height of 25 microns, reducing the risk of any leakage during the casting process and optimizing material consumption in formwork production. The formwork features (a) hydrostatic membranes, (b) casting inlets, and the joinery connection are integrated, and 3D printed as a part of the formwork segments, making it a uniform geometry for casting, such as shown in FIG. 6A.

For example, an overall formwork 300 is shown with segmentation planes/discretization lines 310 in FIG. 6A based on the build volume of the SLA 3D printer. Assembly and scaffolding occurs as follows. The formwork 300 thus includes an assembly of a plurality of distinct segments 320 that are coupled together to form fluid-tight joints and that together define an open volume 322. Dashed lines indicate the dominant forces within the open volume 322 of the formwork. The discrete segments 320 of the formwork 300 are assembled without any mechanical connections. Instead, the compression-dominant structural shape of the formwork 300 enables a simple interface design, utilizing a male-female interlocking mechanism.

For example, FIG. 6B shows one two-part formwork segment 180 with a first component 182 having an end with a female connector 184 and a second component 186 having an end with a male connector 188 (best seen in FIG. 6E). These interlocking features (male connector 188 and female connector 184) ensure precise alignment of the formwork segments (e.g., of first and second components 182, 186, as well as adjacent segments to the two-part formwork segment 180) during assembly and prevent any concrete leakage during the casting process. For example, the first component 182 has a second end with a male connector 190, while the second component 186 has a second end with a female connector 192 to interface with adjacent formwork segments (not shown). Moreover, the female connector 184 and male connector 188 may have contours or shapes that further enhance alignment and coupling between the components, as shown in FIG. 6E. As will be appreciated by those of skill in the art, the formwork may also be assembled in alternative ways, including via mechanical fasteners and the like.

FIG. 6C shows the first component 182 coupled to the second component 186, where the male connector 188 is seated within the female connector 184. FIG. 6D shows the second end of the first component 182 where the male connector 190 is seated within and coupled to an anchor 194 (like anchors 30 shown in FIGS. 1A-1G). With renewed reference to FIG. 6A, a minimal scaffolding system 330 was designed, like that described in the context of FIGS. 1A-1G. This scaffold system 330 provides support during the formwork assembly 300 and prevents any deflection in the formwork during the casting process. It includes 3D-printed upper and lower holders 332, 334, threaded rods 336, and turnbuckles 338, allowing the scaffolding system 330 to facilitate the structure's leveling in cases of variations in the ground level. The methods of the present disclosure may thus further comprise assembling an additively manufactured formwork. At least two supporting portions of the formwork respectively define a first member or arm having a first end and a second member or arm having a second end. The assembling may comprise anchoring the first end to the surface and the second end to the surface, followed by disposing the one or more temporary scaffold supports between the surface and one or more intermediate points along the first arm and the second arm. The methods of assembling may further comprise adding one or more upper segments of the additively manufactured formwork to connect at least the first member or arm and the second member or arm.

In certain aspects, the method may further comprise assembling the additively manufactured formwork that includes at least three supporting portions each respectively defining a first member or arm having a first end, a second member or arm having a second end, and a third member or arm having a third end. The assembling comprises anchoring the first end to a surface, the second end to the surface, and the third end to the surface, followed by placing the one or more temporary scaffold supports between the surface and one or more intermediate points along the first arm, the second arm, and the third arm.

In certain aspects, the method further comprises removing the one or more scaffold supports after the slurry material has solidified and formed the compression-based structure.

The method may further comprise removing the additively manufactured formwork after the slurry material has solidified as the compression-based structure.

In certain aspects, casting methods may involve simultaneous casting from multiple inlets or sequential casting for each respective casting sequence. For example, each sequence of casting for all legs is completed before proceeding to the following sequence during casting.

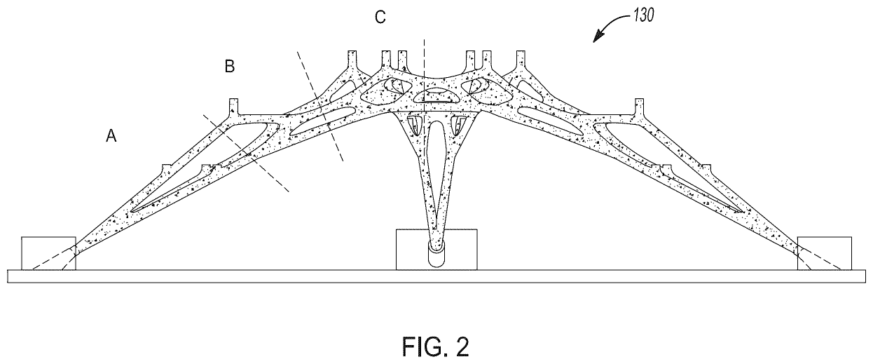

The flowability of concrete within interconnected branched formwork can also dictate the strategic casting sequence. In one example, in a compression-based structure having three support legs and interconnected networks from one leg to another, the legs may all be cast simultaneously to ensure successful casting, otherwise concrete may move from one leg to another through the interconnected casting. Analyzing how the liquid slurry (e.g., concrete precursor) moves and settles within the formwork thus makes it possible to ascertain whether casting may be conducted in a single cast or if it may be advantageous for conducting multiple casts simultaneously In certain other variations, an additively manufactured formwork for making a compression-based structure is provided, which may be made via the additive manufacturing techniques described above. See for example, FIG. 2 showing a depiction of an assembled 3D printed formwork assembly 130 comprising nine segments with three distinct levels (A, B, C) for sequential casting of slurry material and corresponding to the three respective segments, first casting segments 50, second casting segments 52, and third casting segments 54, of formwork 40 shown in FIGS. 1A-1G. Plastic/polymeric formwork is lightweight, reusable, and easy to transport and assemble, as well as being versatile during construction and assembly, making it an efficient and cost-effective solution for creating complex shapes and geometries. It also allows for greater precision and accuracy in the fabrication process, which can provide structures with higher quality and durability. The use of additively manufactured/3D-printed polymeric formwork assemblies in compression-based structures has the potential to revolutionize how structures are built, making them more rapidly, at less expense, and more sustainably.

The additively manufactured formwork may comprise an additively manufactured polymeric structure defining an open volume configured to receive a slurry material and corresponding to the compression-based structure including at least two supporting portions. The additively manufactured polymeric structure optionally comprises a first member or arm defining a first supporting portion of the compression-based structure and having at least two openings including a first opening at a first elevation of a first casting channel in fluid communication with the open volume and a second opening at a second elevation of a second casting channel above the first elevation. At least one support scaffold structure is configured to be disposed under one or more intermediate points or regions of the first member or arm. A second member or arm defines a second supporting portion of the compression-based structure and has at least two openings including a third opening at a first elevation of a third casting channel in fluid communication with the open volume. The first elevation of the first opening of the first casting channel and the third opening of the third casting channel are the same, and a fourth opening at a second elevation of a fourth casting channel above the first elevation. The second elevation of the second opening of the first casting channel and the fourth opening of the fourth casting channel are the same, meaning they share the same elevation or height from the substrate below. Further, at least one support scaffold structure is configured to be disposed under one or more intermediate points or regions of the second member or arm. In certain aspects, the additively manufactured polymeric structure further comprises at least one additional member or arm, such as a third member or arm defining a third supporting portion of the compression-based structure and having at least two openings including a fifth opening at a first elevation of a fifth casting channel in fluid communication with the open volume. The first elevation of the first opening of the first casting channel, the third opening of the third casting channel, and the fifth opening of the fifth casting channel are the same, meaning they all share the same elevation or height from the substrate below. A sixth opening of a sixth casting channel is disposed in the third member or arm at a second elevation above the first elevation, where the second elevation of the second opening of the first casting channel, the fourth opening of the fourth casting channel, and the sixth opening of the sixth casting channel are the same. In certain aspects, at least one support scaffold structure is configured to be disposed under one or more intermediate points or regions of the third member or arm.

In certain aspects, the additively manufactured formwork comprises multiple segments connected to one another. For example, in certain variations, the additively manufactured formwork may further comprise adding one or more upper segments to connect at least the first arm and the second arm and optional or further additional arms, where the one or more upper segments each comprises an additional opening to an additional casting channel fluidly connected to the open volume of the additively manufactured formwork.

In certain aspects, the additively manufactured formwork may comprise (a) inlets for sequential concrete/slurry casting (where the inlets are placed to facilitate sequential casting) and (b) a hydrostatic membrane shaping the cast segment interface to maintain perpendicularity to internal compression forces. The hydrostatic membrane may be aligned perpendicular to the dominant flow of compressive forces, to ensure the casting interface is perpendicular to the dominant flow of compressive forces.

In certain variations, the inlet for casting concrete is higher (in the z plane) than an overall height for its relative sequential casting segment. A minimum height of casting inlet openings may be on the same Z plane of the hydrostatic membrane for each casting cycle. This enables the slurry to flow through the interconnected channels, filling each segment adequately until complete saturation is achieved to form the casting interface perpendicular to the compressive forces during the designated casting cycle. In specific variations, inlets may have a minimal height to conserve formwork material. In this case, the casting may use a pressurized slurry/concrete casting, with the cap/lead used after casting at the inlet.

As will be appreciated, there is a direct relationship between the thickness and profile of the formwork, the location of the hydrostatic membrane (in z plane of the overall structure) and the hydrostatic law of pressure of the slurry being cast (concrete slurry). The hydrostatic membrane informs an end for each sequential cast of slurry material. Each hydrostatic membrane may be placed based on the following considerations: 1) how high the segment being cast will be considering the hydrostatic pressure of concrete against formwork to avoid the formwork breaking; (2) the number of casting stages may depend upon the thickness of the ultra-lightweight formwork and the maximum hydrostatic pressure the formwork can withstand. The thickness and profile of the formwork directly influence the placement of the hydrostatic membrane within the overall structure (z-coordinate) and adhere to the hydrostatic law of pressure applied by the cast slurry (concrete slurry). This membrane thus influences the conclusion for each sequential cast. Its positioning is determined by factors such as the maximum height achievable for segment casting and considering the concrete's hydrostatic pressure against the formwork. In other words, the number of casting stages may be contingent upon the thickness of the ultra-lightweight formwork and its capacity to withstand the maximum hydrostatic pressure. Furthermore, placement of the hydrostatic membrane(s) may be determined in relation to the flowability of the liquid slurry material within the interconnected branched formwork. For example, strategic placement of the hydrostatic membranes can act as a barrier preventing the liquid slurry/casting material from inadvertently entering branches designated for subsequent casting stages in the complex branched formwork system. The optimal placement of these hydrostatic membranes assists with controlling the flow direction of liquid slurry/casting material, ensuring it moves to the intended open areas in the framework without causing overpressure or flowing into areas meant for later stages of casting.

In certain variations, the present disclosure further contemplates preventing air gaps in the formwork, which may be achieved by the following: (1) incorporating cavities or holes in the hydrostatic membrane or (b) alternatively, an air/gas outlet in the formwork, such as a bleed hole, that is positioned near (e.g., as close as possible based on the design) to the hydrostatic membrane.

### EXAMPLE

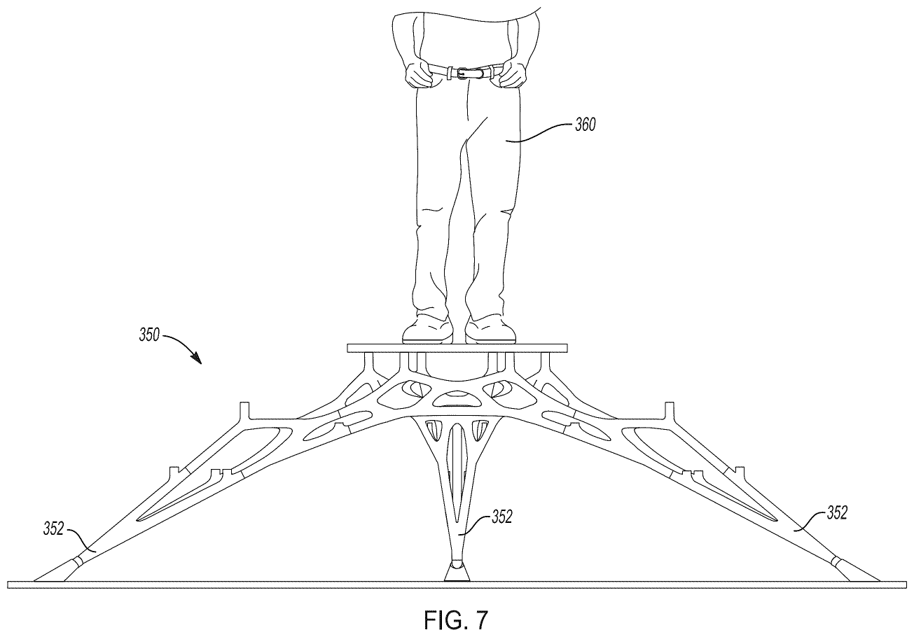

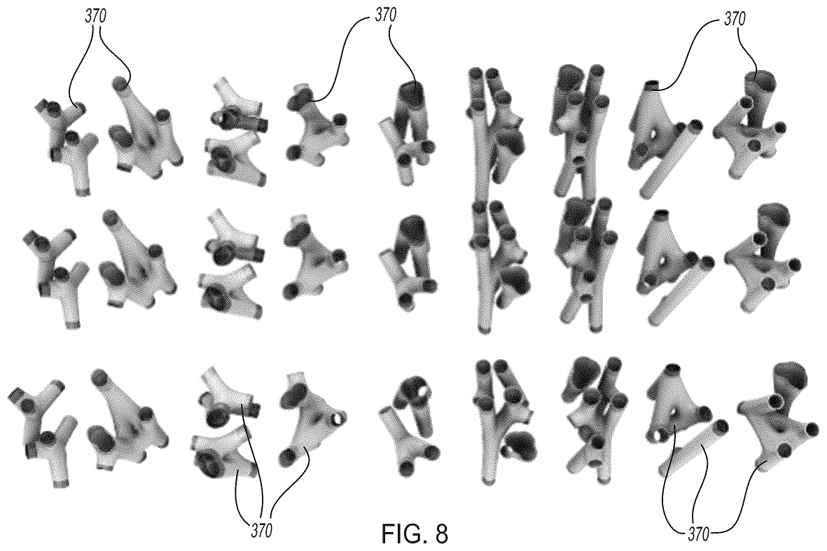

A 1:1 scale table leg structure, Cavity Shell, measuring 1.4 meters in radius and 0.8 meters in height, was designed and built. This compression-only structure 350 with three support members 352 entails intricate and interconnected branched tubular geometries as shown in FIG. 7, which would have been almost impossible to fabricate using another fabrication method than 3D printing formwork and casting concrete. As shown, the compression-only structure 350 is free of metal reinforcements, but is load-bearing and is demonstrated to support at least the weight of a human 360.

Form-Force Diagram: The form-finding process involved generating the form diagram based on the 3DGS approach. This approach was employed using the PolyFrame plug-in for Grasshopper. Using this parametric plug-in, an algorithm was developed to iteratively subdivide and transform a tetrahedron, which served as the initial force polyhedral diagram. These transformations were controlled and modified by various design constraints such as table dimensions, the number of branching edges, maximum and minimum edge lengths, and angles between them until the desired form diagram was achieved-the form-finding stage results in a multi-branched network of lines representing a compression-only structure.

Form Realization: The form diagram was translated into a volumetric model using a circular cross-section representing the geometry of the intended concrete structure. The circular cross-section ensured uniform stress distribution and smooth concrete flowability during the casting process. The resulting tubular branches range from 30 mm to 90 mm in diameter, emphasizing a thicker node where multiple branches converge. To ensure optimal concrete flowability during casting, the confluence between the branches was smoothed and rounded, facilitating easy movement of fluid concrete within the form during the casting process.

Formwork Design: A parametric model was developed to integrate formwork features based on the structural and casting logic. In Cavity Shell, the SC was divided into three casting cycles based on the height value achieved from the hydrostatic equation. This division determined the placement of the 1 mm thick hydrostatic membranes, resulting in 15 cold joints in the formwork. The position and alignment of these membranes informed the integration of casting inlet parameters, such as their position, height, and diameter, into the parametric model. Additionally, this computational model also analyzed the integration of casting inlets parallel to horizontal branches in the form to utilize pressure differences and assist in directing the concrete flow horizontally. Based on the formwork prototyping, a constant thickness of 1.5 mm was maintained throughout the formwork, making it ultra-lightweight to transport to the site.

3D Printing: A setup of three SLA 3D printers, each having a build volume of 219 mm×123 mm×250 mm, was used to 3D print the formwork of Cavity Shell using ABS-like resin. The entire formwork was segmented into 54 discrete 3D printed segments 370 based on the build volume of the 3D SLA printers and was distributed over 27 prints, as shown in FIG. 8. These 54 discrete segments were printed at a layer height of 50 microns culminating in a total printing time of approximately 400 hours. In addition to these formwork segments, 21 custom scaffolding structures, accounting for a total of 42 parts, i.e., 21 lower and 21 upper parts with a 25% infill, were also printed on the SLA 3D printer using ABS-like resin and took around 60 hours of print time to complete.

Assembly and Casting: The formwork assembly relied on scaffolding holders comprising 3D printed holders, 5/16 inch threaded rods and turnbuckles, and 54 discrete 3D SLA printed segments 370 in FIG. 8. These scaffolding holders were instrumental in securing the structure's position and mitigating any deflection during the casting process. Cavity Shell's formwork was assembled on a medium density fiber (MDF) base, supported by 21 vertical scaffolds and three 3D SLA-printed foundations for optimal load transfer to the ground.

Commercial Portland fast-setting concrete was used for sequential casting in 3 cycles. Each cycle took approximately 40 minutes to cast and two and a half hours of setting time between each pouring cycle. The formwork assembly took less than 24 hours, and the casting process was successfully conducted within a day, demonstrating the success of 3D-printed polymeric formwork and sequentially casting it for constructing a compression-only concrete structure.

The Cavity Shell assembled formwork in this example successfully demonstrated an in-situ construction of a compression-only concrete structure using 1.5 mm thick 3D printed ultra-lightweight polymeric formwork for sequential casting method. The entire formwork was only 5.2 kgs and took less than 48 hours to assemble and sequentially cast by two people. The cavity shell structure formwork measuring 1.4 meters in radius and 0.8 meters in height, utilized a total of 36 kgs of concrete. As compared to the heavy falsework required to construct a traditional compression-only structure made up of either heavy 3DCP components or small bricks/stones, the cavity shell only used 12 pieces of scaffolding to assemble the formwork and successfully avoided any deflection during the casting process. The formwork easily withstood the hydrostatic pressure during the sequential casting process, demonstrating the potential of 3D polymeric formwork printing for this method. Even if the structure is scaled up by multiple times, e.g., 5-10 times greater, a total weight of the formwork and concrete used for casting would still be comparatively less than the weight of components used in compression-only structures like Striatus or Armadillo made on an architectural scale. Factors like weight reduction of formwork and decreased amount of scaffolding contribute to easy transportation to the construction site and reduced construction costs.

Cast formwork after the second casting cycle showed no leakage and formed cold joints perpendicular to the dominant flow of compressive forces enabled by integration of hydrostatic membranes in the formwork.

The 3D Graphic Statics method was used in this variation to design a compression-only structure (but other methods may also be used to design such structures). This design method combined with construction methods allows for developing intricate tubular compression-only form with the minimized volume of concrete and carbon footprint, while maintaining the necessary mass for structural performance and specific architectural detailing. This intertwined tubular topology ranging from 30 mm-90 mm in diameter highlights the optimized load-bearing capabilities of this compression-only system by not only taking its dead load but also maintaining its structural integrity after external load. FIG. 7 shows a human standing on a load-bearing compression-only structure.

Using SLA 3D printing for formwork joints with a thickness of 0.75 mm enabled precise fitting that successfully eliminated any leakage during the casting process. To ensure symmetrical load distribution on the formwork and to control the atmospheric pressure which impacts the concrete flowability inside the formwork, it was observed that the sequential casting process is carried out concurrently from all the inlets in the same Z plane or elevation of the structure. While the tubular formwork geometry allowed easy flowability of concrete and successfully resisted the hydrostatic pressure, the formwork was vibrated locally to remove the air gaps while casting in the form's horizontal branches. In conclusion, this example demonstrates digital design to materialization workflow of 3D printing ultralightweight formwork and sequential casting to construct compression-only structures. This integration of in-situ sequential casting of 3D printed formwork with compression-only structures provides the potential to rethink the construction of compression-only structures by minimizing the material used and improving economic and environmental efficiency in their construction life cycle.

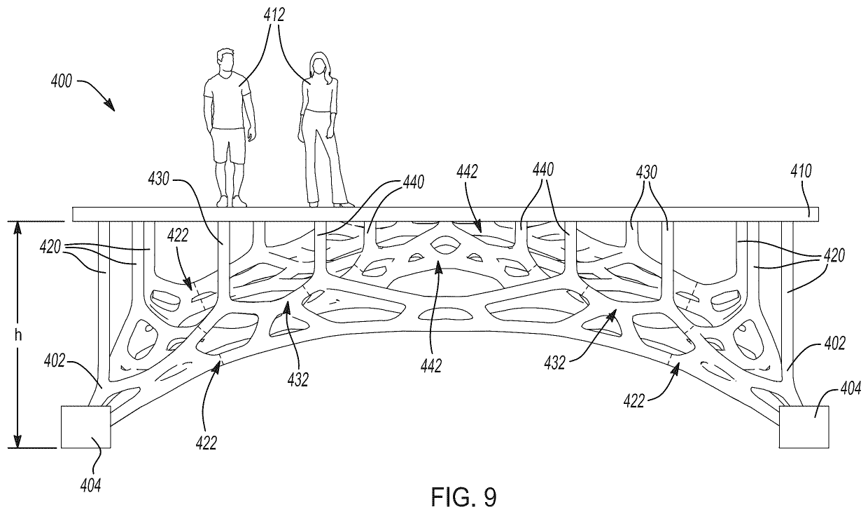

FIG. 9 shows an alternative cast-in-place compression-based structure 400 formed according to alternative methods of the present disclosure. In contrast to FIG. 7, each of the casting inlets extends to a single plane (e.g., a lateral plane corresponding to a walkable level). In this manner, the compression-based structure supports a substrate defining a flat surface (or alternatively, could be designed to support a curved surface where the inlets have heights corresponding to the curved substrate disposed over them). The substrate may be a floor or road in a slab or bridge.

In FIG. 9, the compression-based structure 400 may be formed by an assembled multi-part lightweight additively manufactured formwork (not shown) having a plurality of hydrostatic membranes in an open volume, like the variations described in the context of FIGS. 4A-4C above. The hydrostatic membranes serve to direct the liquid slurry to appropriate open regions and to predetermined levels/heights within the formwork to provide sequential casting, as described above. This compression-based structure 400 has multiple supporting sections or members (e.g., arms 402) that connect to anchors 404 in the ground or lower substrate. As with previous variations, the compression-based structure 400 can include intricate and interconnected branched tubular geometries as shown in FIG. 9, which would have been almost impossible to fabricate using another fabrication method than 3D printing formwork and casting concrete. As shown, the compression-based structure 400 is free of metal reinforcements, but is load-bearing and is demonstrated to support a flat substrate 410 and the weight of multiple humans 412.

Compression-based structure 400 may be formed by a formwork having multiple distinct levels that may be delineated at least in part by placement of hydrostatic membranes, including a set of first casting segments that will define a first level of slurry filling, a set of second casting segments that will define a second level of slurry filling above the first level, and a set of third casting segments that will define a third level of slurry filling above the first and second levels of slurry, much like those described in FIGS. 4A-4C. Thus, the compression-based structure 400 has first vertical structures 420 corresponding to first casting channels in the formwork (not shown) that extend to an elevation or height “h.” Thus, the first vertical structures 420 correspond to first casting channels 222 having openings 220 in FIGS. 4A-4C, except that they extend to a higher elevation (h). Material may be introduced into the first casting channels so that it fills a first lower portion of the formwork to a first level and creates a first lower portion 422 of the compression-based structure 400 that is connected to the first vertical structure 420. The compression-based structure 400 also comprises second vertical structures 430 that also extend to the elevation or height “h.” Thus, the second vertical structures 430 correspond to second casting channels 232 having second openings 230 in FIGS. 4A-4C. Material added in the second stage of casting fills the formwork to the second level and creates a second lower portion 432 of the compression-based structure 400 that is connected to the second vertical structure 430. Finally, the compression-based structure 400 also comprises third vertical structures 440 that likewise extend to the elevation or height “h.” Thus, the third vertical structures 440 corresponds to third casting channels 242 having second openings 240 in FIGS. 4A-4C. Material added in the third (and here final) stage of casting fills the formwork to the third level and creates a third upper portion 442 of the compression-based structure 400 that is connected to each of the third vertical structures 440. In this manner, each of the first, second, and third vertical structures 420, 430, 440 all extend to the same height (h) and same plane, such that they can support a solid planar structure, like substrate 410 shown. In this variation, the casting inlets in the formwork serve a dual purpose by also functioning as the vertical supports (first, second, and third vertical structures 440) for load transfer. The height of the casting inlets can extend to the floor or substrate level. Further, additional casting inlets may be introduced to the formwork that can address the necessary load transfer for the final support needed in the compression-based structure 400 that may not otherwise be required simply for the casting process.

As noted above, sequentially casting this ultra-lightweight compression-only formwork can apply to various structures and components, like slabs, bridges, ribbed structures, such as gothic vault systems and buttresses, floor systems, ceilings, columns, furniture, or any compression-only pavilion/structure with or without tension members and with or without a rebar system. This expands the possibilities of cast-in-place concrete structures while reducing the risk of cracking the ultra-thin formwork due to hydrostatic pressure. Further, use of other cementitious or non-cementitious materials like clay, biomaterial, sawdust, wood-based, and earth-based materials for casting and creating structural components is possible contributing to a more sustainable construction industry. In certain variations, the materials may include an organism or organism-derived material, such as mycelium, that can grow within the structure.

In certain other variations, tensile membranes, such as rebar, post-tensioning wires, tensioning mesh, and the like, are integrated into the 3D-printed formwork before or after assembly and introduction of the slurry liquid. This addition may be necessary to accommodate other live loads exerted on the structure. In variations where the compression-based structure resembles a shell or is a hybrid of shell and ribs, the shells may also incorporate tensile membranes, such as a tensile mesh that can be manually inserted into the 3D-printed formwork. These tension elements or mesh can be physically integrated as a different material while assembly or 3D printing occurs within the formwork.

Thus, in various aspects, the present disclosure contemplates methods for constructing compression-based structures (e.g., made from concrete, masonry, earth, etc.) based on prefabrication of large-scale 3D printed lightweight formwork, and assembly. The 3D printed lightweight formwork thus has designated inlets to designated casting channels designed for the on-site casting of concrete, clay, earth-base or any castable material. The method may involve assembling the segments of formwork into a compression-based form using a minimal temporary scaffolding system. The method may thus involve introducing casting material (e.g., slurry that forms concrete) in formwork through the inlets in sequences to build up levels of material within the formwork. The method optionally involves sequentially pouring with the staggered time offset to permit the setting of cast material. In a structure made of typical concrete mix (without an accelerator), the method involves pouring the concrete into the formwork, allowing it to set, and then pouring the next section. In concrete structures using the set-on-demand concrete mix, the mix undergoes a chemical reaction to harden and gain strength as demanded. In certain variations, the formwork further comprises one or more hydrostatic membranes disposed in the open volume to be filled to enhance cold joint integrity and strength between sequentially cast levels. Both of the casting approaches may also be used with clay and earth-based materials for example. In this manner, any compression-based structure can be formed, such as construction of domes, vaults, bridges, tunnels, slabs, beam, ribbed structures, such as gothic vault systems and buttresses, shell-like structures in compression, and large-scale infrastructure projects, or any other compression-based or compression-only structures by way of example.

As such, the present disclosure contemplates new methods of construction of compression-based structure using 3D printing lightweight integrative formwork (e.g., formed with plastic, carbon fiber, and bio-polymer) that is assembled on-site in a compression-based form and then filled sequentially with concrete to form the compression-based structure. The present disclosure further contemplates methods that guide the design, segmentation, 3D printing, and assembly of such formwork. It also provides methods to cast the formwork, as described above.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method of making a compression-based structure comprising:
introducing a first amount of a slurry material into at least one first opening of a first casting channel in fluid communication with an open volume of an additively manufactured formwork, wherein the open volume of the formwork defines the compression-based structure and the introducing the first amount of slurry fills the open volume to a first level, wherein the additively manufactured formwork is supported by one or more scaffold supports; and
further introducing an additional amount of slurry material into at least one additional opening of an additional casting channel of the formwork that is in fluid communication with the open volume so that the additional amount of slurry material fills the open volume to a second level above the first level, wherein the slurry material solidifies to form the compression-based structure within the formwork.

2. The method of claim 1, wherein the formwork further comprises at least one hydrostatic membrane disposed in the open volume of the formwork lower than a height of the at least one first opening of the first casting channel.

3. The method of claim 2, wherein the open volume defines a longitudinal axis and the at least one hydrostatic membrane is disposed in the open volume in an orientation substantially orthogonal to the longitudinal axis.

4. The method of claim 2, wherein the at least one hydrostatic membrane defines an interface between the first level and the second level.

5. The method of claim 2, wherein the at least one hydrostatic membrane comprises at least one vent.

6. The method of claim 1, wherein the at least one additional opening comprises a second opening in a second casting channel of the formwork that is in fluid communication with and connects to the open volume and a third opening in a third casting channel of the formwork that is in fluid communication with and connects to the open volume, wherein the further introducing further comprises:
introducing at least a second amount of the slurry material into the second opening of the second casting channel of the formwork, so that the second amount of the slurry material fills the open volume to a second level above the first level; and
introducing at least a third amount of the slurry material into the third opening of the third casting channel of the formwork, so that the third amount of the slurry material fills the open volume to a third level above the second level.

7. The method of claim 6, wherein the compression-based structure is a monolithic solid having layers corresponding to the first level, the second level, and the third level.

8. The method of claim 6, wherein the formwork further comprises at least one first hydrostatic membrane disposed in the open volume of the formwork lower than a first height of the at least one first opening of the first casting channel and at least one second hydrostatic membrane disposed in the open volume of the formwork lower than a second height of the at least one second opening of the second casting channel, wherein the at least one first hydrostatic membrane defines an interface between the first level and the second level and the at least one second hydrostatic membrane defines an interface between the second level and the third level.

9. The method of claim 8, wherein the open volume defines a longitudinal axis and each of the at least one first hydrostatic membrane and the at least one second hydrostatic membrane is disposed in the open volume in an orientation substantially orthogonal to the longitudinal axis.

10. (canceled)

11. The method of claim 8, wherein the at least one first hydrostatic membrane and the at least one second hydrostatic membrane each comprises at least one vent.

12. The method of claim 1, wherein the introducing the first amount of the slurry material comprises introducing the first amount of slurry material into at least two distinct first openings of two distinct first casting channels in fluid communication with the open volume so the first amount of slurry material fills the open volume to a first level and the further introducing the additional amount of slurry material comprises introducing the additional amount of slurry material into at least two additional openings of two additional casting channels in fluid communication with the open volume so that the additional amount of slurry fills the open volume to the second level above the first level.

13. (canceled)

14. The method of claim 1, wherein the compression-based structure defines at least one arch, dome, vault, shell, slab, bridge, beam, or ribbed structures.

15. (canceled)

16. The method of claim 1, wherein the further introducing the additional amount of slurry occurs greater than or equal to about 5 minutes to less than or equal to about 24 hours after the introducing of the first amount of slurry.

17. The method of claim 1, wherein the slurry material comprises a material selected from the group consisting of: cementitious materials, clay, earth-based materials, masonry, starch, dirt, bio-material, and combinations thereof and an accelerator.

18-20. (canceled)

21. The method of claim 1, wherein the compression-based structure is formed on a surface and the compression-based structure includes at least two supporting portions that each contact the surface on one end and the method further comprises assembling the additively manufactured formwork, wherein the at least two supporting portions of the formwork respectively define a first member having a first end and a second member having a second end, wherein the assembling comprises anchoring the first end to the surface and the second end to the surface, followed by disposing the one or more scaffold supports between the surface and one or more intermediate points along the first member and the second member.

22. The method of claim 21, further comprising adding one or more upper segments of the additively manufactured formwork to connect at least the first member and the second member.

23-24. (canceled)

25. The method of claim 1, further comprising removing the one or more scaffold supports after the slurry material has solidified and formed the compression-based structure and/or removing the additively manufactured formwork after the slurry material has solidified and formed the compression-based structure.

26. (canceled)

27. The method of claim 1, wherein the compression-based structure is free of any metal reinforcements.

28. The method of claim 1, wherein the open volume of the additively manufactured formwork further comprises at least one metal reinforcement and after the slurry material solidifies, the compression-based structure comprises the at least one metal reinforcement.

29. An additively manufactured formwork for making a compression-based structure, the additively manufactured formwork comprising:
an additively manufactured polymeric structure defining an open volume configured to receive a slurry material and corresponding to the compression-based structure including at least one supporting portion having at least two openings including:
a first opening of a first casting channel at a first elevation in fluid communication with the open volume; and
a second opening of a second casting channel at a second elevation above the first elevation in fluid communication with the open volume,
wherein the at least one supporting portion defines one or more first regions configured to have a support scaffold structure disposed thereunder.

30. The additively manufactured formwork of claim 29, wherein the formwork further comprises:
a first hydrostatic membrane disposed in the open volume of the formwork at the first elevation that is lower than the first height of the first opening of the first casting channel.

31. The additively manufactured formwork of claim 30, wherein the first hydrostatic membrane comprises at least one vent.

32-44. (canceled)
